(19) United States
(12) Patent Application Publication
(10) Pub. No.: US 2019/0147461 A1
(43) Pub. Date: May 16, 2019

(54) METHODS AND APPARATUS TO ESTIMATE TOTAL AUDIENCE POPULATION DISTRIBUTIONS

(71) Applicant: The Nielsen Company (US), LLC, New York, NY (US)

(72) Inventors: Michael Sheppard, Holland, MI (US); Jake Ryan Dailey, San Francisco, CA (US); Dipti Shah, Pleasanton, CA (US); Beate Sissenich, New York, NY (US); Ludo Daemen, Duffel (BE)

(21) Appl. No.: 15/812,768

(22) Filed: Nov. 14, 2017

(51) Int. Cl. G06Q 30/02

(52) U.S. Cl. CPC G06Q 30/0201; G06F 9/3001

(57) ABSTRACT

Methods, apparatus, systems and articles of manufacture are disclosed to store first impression counts of first media impressions corresponding to panelists in a population that accessed media via one or more of a plurality of media access platforms; and store marginal impression counts for second media impressions corresponding to audience members in the population that accessed the media via the plurality of media access platforms, ones of the marginal impression counts indicative of a total number of impressions of the media accessed via corresponding ones of the plurality of media access platforms; calculate multipliers relating a first probability distribution of the first media impressions to a second probability distribution of the second media impressions, the multipliers calculated based on constraints defined by the marginal impression counts for the second media impressions; and calculate second impression counts of the second media impressions based on the multipliers.

### FIELD OF THE DISCLOSURE

This disclosure relates generally to processor systems, and, more particularly, to adapting processor system operations to estimate total audience population distributions.

### BACKGROUND

Traditionally, audience measurement entities determine audience exposure to media based on registered panel members. That is, an audience measurement entity (AME) enrolls people who consent to being monitored into a panel. The AME then monitors those panel members to determine media (e.g., television programs or radio programs, movies, DVDs, advertisements, webpages, streaming media, etc.) exposed to those panel members. In this manner, the audience measurement entity can determine exposure metrics for different media based on the collected media measurement data.

### BRIEF DESCRIPTION OF THE DRAWINGS

FIG. 1A illustrates an example communication flow diagram of an example manner in which an audience measurement entity (AME) can collect impressions and/or demographic information associated with audience members exposed to media.

FIG. 1B depicts an example system to collect impressions of media presented on mobile devices and to collect impression information from distributed database proprietors for associating with the collected impressions.

FIG. 2 depicts a table of example media exposure information across three platforms gathered from a panel of audience members.

FIG. 3A depicts a table of example media exposure information across three platforms gathered from a population of audience members and collected from database proprietors.

FIG. 3B depicts an example generalized table of the table of FIG. 3A.

FIG. 4 depicts an example generalized table of the table of FIG. 2.

FIG. 5 is an example constraints table for a census data probability distribution that shows an example relationship between gathered census data and constraints.

FIG. 6 is a block diagram of the example impression frequency distribution analyzer of FIGS. 1A and/or 1B.

FIGS. 7-9 are flowcharts representative of example machine readable instructions that may be executed to implement the example impression frequency distribution analyzer of FIG. 6.

FIG. 10 is an example processor platform that may be used to execute the example instructions of FIGS. 7, 8, and/or 9 to implement the example impression frequency distribution analyzer of FIG. 6 to estimate total audience population distributions in accordance with the teachings of this disclosure.

### DETAILED DESCRIPTION

AMEs usually have large amounts of audience measurement information from their panelists including the number of unique audience members for particular media and the number of impressions corresponding to each of the audience members across different combinations of platforms. A media access platform, henceforth referred to as simply a “platform,” as used herein, is the means by which a person accesses or is exposed to a piece of media. Examples of a media platform include a television, a mobile device, a desktop computer, a radio, a newspaper, a magazine, etc. Platforms may also be defined as groups of other smaller platforms. For example, the “digital” platform refers to mobile devices, desktop computers, and other forms of computer devices. For purposes of explanation, the examples disclosed herein primarily refer to three platforms including television, desktop (short for desktop computers), and mobile (short for mobile devices). As used herein, mobile devices (associated with the “mobile” platform) refers to smartphones, cell phones, tablets, PDAs, and other portable handheld computer devices. However, the below examples may be expanded and/or adapted to apply to any other platforms.

Unique audience size, as used herein, refers to the total number of unique people (e.g., non-duplicate people) who had an impression of a particular media item, without counting duplicate audience members. For example, if 20 people were exposed to an advertisement on television and 30 people were exposed to the advertisement on desktop computers, the unique audience size for this advertisement is somewhere between 30 and 50 people. For example, if all 20 people who were exposed to the advertisement on television, were also exposed to the advertisement on desktop (and, thus, are included in the group of 30 people), the unique audience size is 30. Similarly, if all 20 of those people who were exposed to the advertisement on television were distinct from the 30 people who were exposed to the ad on desktop, the unique audience size is 50 people.

Impression count, as used herein, refers to the number of times audience members are exposed to a particular media item. In some instances, impressions may be counted separately for different platforms. For example, if a person is exposed to an advertisement three times on a desktop and two times on television, that person had three impressions for desktop, two impressions for television, resulting in total of five impressions. The total impression count of a particular media item is the sum of all impressions for that media corresponding to all audience members.

While each exposure to a particular media constitutes a separate impression, the number of times a particular home or individual is exposed to the media within a specified time period or duration is referred to as the impression frequency or simply, frequency. Thus, if each of six people is exposed to a particular advertisement once for a particular duration and each of four other people is exposed to the same advertisement twice for the same duration, the impression frequency for each of the first six people would be one while the impression frequency for each of the latter four people would be two. The impression count for the particular advertisement during a particular duration can be derived by multiplying each frequency value by the unique audience size corresponding to that frequency to generate a product for each frequency, and summing the products. Thus, in the above example, the impression frequency of one multiplied by the six unique audience members plus the impression frequency of two multiplied by the four unique audience members results in 1×6+2×4=14 total impressions for the advertisement.

For any group of people exposed to a media item, it is useful, for predictive purposes, to develop estimated joint distributions of impressions across one or more platforms. A joint probability distribution, as used herein, refers to a type of probability distribution that estimates the likelihood of a particular combination of two or more variables occurring, given a data set of those variables. The data set of the variables constrains the probability distribution by acting as data to which the distribution is to fit. Individual values within the constraining data set are called “constraints.”

Specifically, AMEs may generate estimated joint probability distributions across three variables, namely, impression count, platform, and unique audience size. Probability distributions generated by AMEs are both non-negative and discrete (e.g., only include positive integers and zero) because audience size and impression count values are always non-negative integers. These probability distributions, or more generally the estimations they make, allow for accurate predictions to be made for exposures of monitored media.

While raw data collected from panelists is useful in many cases, creation of joint probability distributions allows for accurate estimations of media exposures of individual audience members across the platforms of interest. For example, an AME may know how many unique panelists had impressions on two platforms (e.g., five panelists had a total of 20 impressions on both television and desktop) and how those impressions were divided amongst those platforms (e.g., 13 of the 20 were on television and seven of the 20 were on desktop) but not know the likelihood of a panelist having a combination of impressions on a combination of platforms (e.g., given a panelist with at least one impression on television and 1 impression on desktop, a probability distribution may estimate that the panelist has a 5% chance of having three impressions on television and two on desktop). As used herein, a joint probability distribution over a group of panelists, is referred to as a “panel probability distribution.”

In many examples, AMEs also gather media exposure information associated with audience members indirectly from providers of the media to which the audience members are exposed. For example, in the context of television, cable, satellite, or other television, providers may collect data about the media their subscribers access and share such data with an AME. For television, such data collected directly from content providers is sometimes referred to as return path data. In the online context, internet providers may collect and provide metrics concerning the media accessed by individuals. In some examples, webpages and/or particular media objects (e.g., an online advertisements) may include embedded instructions that automatically cause a user device accessing the webpages to report impressions of any media contained on the webpage to the AME. Other methods may be employed by an AME to indirectly collect media exposure information without audience members having to enroll as panelists for television, internet, and/or other types of media platforms. Collecting such information has the advantage of being from a much larger number of audience members than is possible using more traditional panels. Indeed, the above approaches make it possible to obtain impressions for virtually every person that accesses media using devices that implement the above methods so that the AME has impression data for virtually all audience members in a total population of interest. Such media exposure information is referred to herein as “census data.”

Census data may include data gathered from both panelists and non-panelists as both groups may access media that is reported to AMEs independent of panelist meters set up by the AMEs. In many examples, the vast majority of census data comes from non-panelists, who make up a much larger percentage of the total population than panelists do. While census data corresponds to a much larger pool of audience members than is practical for a panel, the census data gathered by AMEs is less robust than the panel data. For example, an AME might know how many non-panelists were exposed to an advertisement on a webpage and the total number of impressions for that advertisement based on census data but may not know if those non-panelists were exposed to the advertisement on other media devices or how those impressions are distributed across audience members.

Examples disclosed herein overcome this challenge by estimating census probability distributions using collected panel data in combination with the collected census data. As used herein, a “census probability distribution” refers to a joint probability distribution analogous to a panel probability distribution except applied to a whole population under consideration instead of just a panel. A census population may be a population of one or more countries, one or more states, one or more cities, and/or any other natural or political geographic region; a population that visits one or more websites, subscribes to one or more internet services, uses one or more types of electronic devices to access media, and/or is defined by any other suitable characteristic common across multiple people of interest for monitoring media access behavior. In many examples, the collected census data alone is not enough to create accurate estimated census probability distributions. This is because a census population is typically regarded as made up of anonymous or unknown audience members of which limited demographic information is known (unlike panelists of which detailed demographic information is collected when audience members are enrolled in the panel). As such, census data is typically limited to measures such as the audience size and the impression count attributable to the census audience members for particular platforms. The correspondence, if any, of census audience members exposed to media via different platforms is typically unavailable because of the anonymous nature of the census data. As used herein, the audience size of the census population is called the “universe estimate.”

A census probability distribution is a distribution of the likelihood of any person (e.g., a member of the total population of interest) having a particular number of impressions of a particular media item via particular platforms. For example, the census probability distribution would estimate the likelihood of a particular person having 4 impressions on television and 1 on a mobile phone. In many examples, any type of analytics capable of being performed on a probability distribution (e.g., individual cell probability evaluation and linear combinations) can be performed on a census probability distribution. In many examples, the census probability distribution is immensely valuable to AMEs as it allows them to accurately predict the composition of an audience and the platforms through which exposure to the particular media occurred.

Methodologies for estimating census probability distributions from data collected from panel members and non-panelists have evolved through the years. Previous methodologies have included using adjustment factors, normalizations, and other scaling procedures to match panel data to the known information about the total population. However, these procedures often produce logically inconsistent results. One example inconsistency identified in existing methodologies is an estimated distribution indicating an impression frequency that is less than one. In many examples, this stems from a failure to account for overlap of viewership between media devices. Reducing inconsistencies in estimates increases the accuracy of those estimates. Thus, developing an improved methodology (e.g., one with less inconsistencies) for using panel data to create estimated census probability distributions can be used to improve media exposure estimation.

Examples disclosed herein rely on the principles of maximum entropy (MaxEnt) and minimum cross entropy (MinXEnt) from information theory to generate accurate estimates of the census probability distribution that eliminate logical inconsistencies, such as, frequencies less than 1. Entropy, in information theory, is used in the context of probability distributions. Entropy, as used herein, refers to the randomness (e.g., lack of order) in a system. When a system is in a state of maximum entropy, that system is in the state of maximum possible randomness.

When a system is in a state of minimum entropy, the system is in the state of maximum possible order. As disclosed herein, the principle of maximum entropy is used to determine the panel data probability (Q). Next, using the panel probability distribution, the principle of minimum cross entropy can then be applied to generate a census probability distribution (P) that is consistent with the panel probability distribution and constraints defined by gathered census data.

The maximum entropy principle is a principle that states that the most accurate probability distribution, given consistent known constraints, is the one that maximizes entropy in a system. Generally speaking, this principle can be stated mathematically as:

$${maximize}_{Q} H ( Q ) = - {\sum }_{I = 1}^{∞} {q}_{\{ i \}} log ( {q}_{\{ i \}} ) \qquad ( 1 )$$

where qᵢ is an individual probability element of the array comprising, Q, the probability distribution to be found, and H is the entropy of the distribution. In examples disclosed herein, the known constraints will be discrete (e.g., discontinuous and countable). Considering this limitation, an example set of constraints is:

$$[ \begin{matrix}1 & 1 & 1 & 1 \\ 7 & 3 & 2 & 1 \\ 0 & - 1 & - 3 & 0\end{matrix} ] [ \begin{matrix}{q}_{1} \\ {q}_{2} \\ {q}_{3} \\ {q}_{4}\end{matrix} ] = [ \begin{matrix}1 \\ 3.5 \\ - 0.5\end{matrix} ] \qquad ( 2 )$$

the column vector on the left-hand side corresponds to the probability distribution Q with four individual probabilities qᵢ. It can be shown that the individual probabilities for the probability distribution estimated using the principle of maximum entropy can be written in terms of Lagrange multipliers (λⱼ), as follows:

q₁=exp((λ₁)(1)+(λ₂)(7)+(λ₃)(0)) (3a)

q₂=exp((λ₁)(1)+(λ₂)(3)+(λ₃)(−1)) (3b)

q₃=exp((λ₁)(1)+(λ₂)(2)+(λ₃)(−3)) (3c)

q₄=exp((λ₁)(1)+(λ₂)(1)+(λ₃)(0)) (3d)

As shown above, the coefficients of each Lagrange multiplier are the same as the columns of the constraint matrix in equation (2). Example equation set (3) can be simplified by defining the following:

zⱼ=exp(λⱼ) (4)

From henceforth, ‘z’ will refer to as the exponential Lagrange multiplier and is mathematically related to λ such that either per equation (4), is interchangeable with one another, as knowing one allows the other to be calculated. Substituting the definition of equation (4) into example equation set (3) gives:

q₁=z₁z₂⁽⁷⁾ (5a)

q₂=z₁z₂⁽³⁾z₃⁽⁻¹⁾ (5b)

q₃=z₁z₂⁽²⁾z₃⁽⁻³⁾ (5c)

q₄=z₁z₂ (5d)

Using expressions for the values of q expressed in example equation set (5), those values can be substituted into example equation (2) allowing for the estimated values for q to be calculated directly by solving for the exponential Lagrange multipliers (z₁, z₂, z₃) in the system equations represented by the matrix. These values of q represent the values q that satisfy the principle of maximum entropy. Knowing each element, q, in the distribution Q, allows the full definition of the entire probability distribution.

The principle of minimum cross entropy, also called the principle of minimum discrimination information, states that given a prior distribution and some consistent constraints, to find a posterior distribution that is as close as possible to the given distribution, the most accurate posterior distribution is the one that minimizes cross entropy. In other words, the most accurate posterior distribution is one that is as least discriminable from the given distribution. Generally speaking, this principle can be stated mathematically as:

$${minimize}_{P} D ( P : Q ) = \sum {p}_{\{ i \}} log ( \frac{{p}_{\{ i \}}}{{q}_{\{ i \}}} ) \qquad ( 6 )$$

where D is the cross entropy; pᵢ is an individual probability element of the array comprising, P, the posterior probability distribution to be found and ‘q’ is the individual probability element of Q, a known probability distribution related to P. In examples disclosed herein, the known constraints will be discrete (e.g., discontinuous and countable). Considering this limitation, an example set of constraints and probability distribution Q are:

$$\begin{matrix}Q = \{ \begin{matrix}.10 & .20 & .50 & .20\end{matrix} \} & ( 7 ) \\ [ \begin{matrix}1 & 1 & 1 & 1 \\ 7 & 3 & 2 & 1 \\ 0 & - 1 & - 3 & 0\end{matrix} ] [ \begin{matrix}{p}_{1} \\ {p}_{2} \\ {p}_{3} \\ {p}_{4}\end{matrix} ] = [ \begin{matrix}1 \\ 3.5 \\ - 0.5\end{matrix} ] & ( 8 )\end{matrix}$$

It can be shown that, using the principle of minimum cross entropy, the individual probabilities of P can be expressed as:

p₁=q₁ exp((λ₁)(1)+(λ₂)(7)+(λ₃)(0)) (9a)

p₂=q₂ exp((λ₁)(1)+(λ₂)(3)+(λ₃)(−1)) (9b)

p₃=q₃ exp((λ₁)(1)+(λ₂)(2)+(λ₃)(−3)) (9c)

p₄=q₄ exp((λ₁)(1)+(λ₂)(1)+(λ₃)(0)) (9d)

Using the same substitution shown in example equation (4) this system can also be expressed as:

p₁=q₁z₁z₂⁽⁷⁾ (10a)

p₂=q₂z₁z₂⁽³⁾z₃⁽⁻¹⁾ (10b)

p₃=q₃z₁z₂⁽²⁾z₃⁽⁻³⁾ (10c)

p₄=q₄z₁z₂ (10d)

Combining equations (7), (8) and, (10) allows numerical solutions for the estimated values of p to be found using the principle of minimum cross entropy.

In some examples, a procedure will be described for capturing the census probability distribution across three platforms, television (TV), desktop computers (DSK), and mobile devices (MBL). These platforms are referenced using subscripts/variables X, Y, and Z, respectively. Gathered census data for these platforms and index numbers for summations use i, j, and k as subscripts, respectively. These choices are not intended to limit this disclosure in scope and are provided merely for purposes of explanation. In other examples, the methodology and apparatus can be applied to other types of media consumption platforms (e.g. radio).

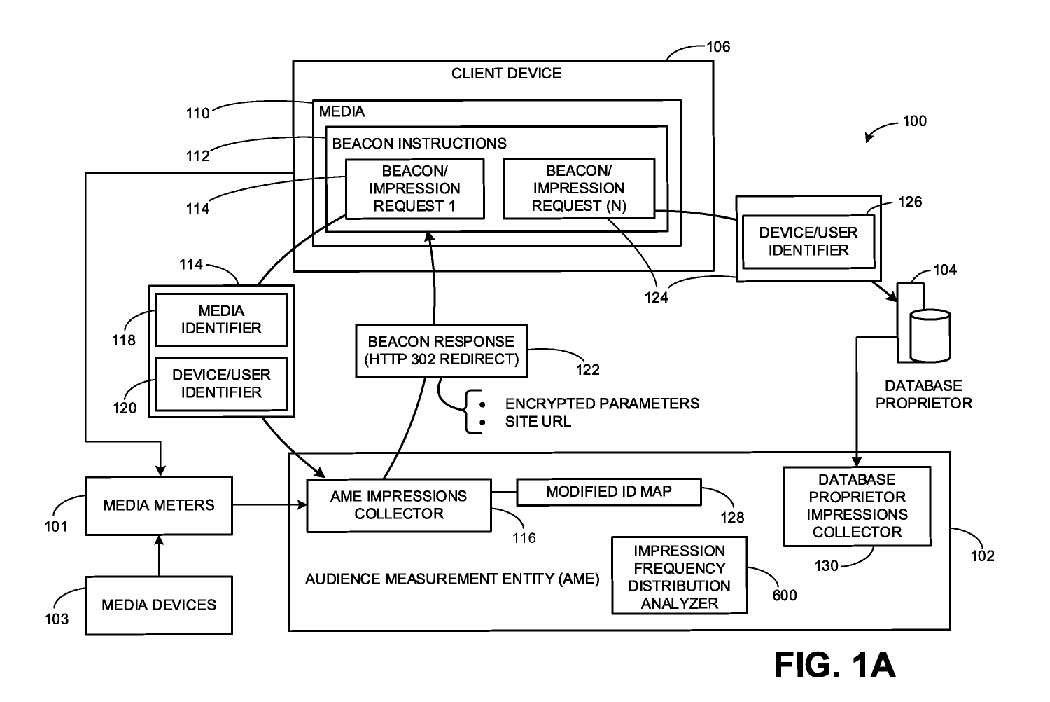

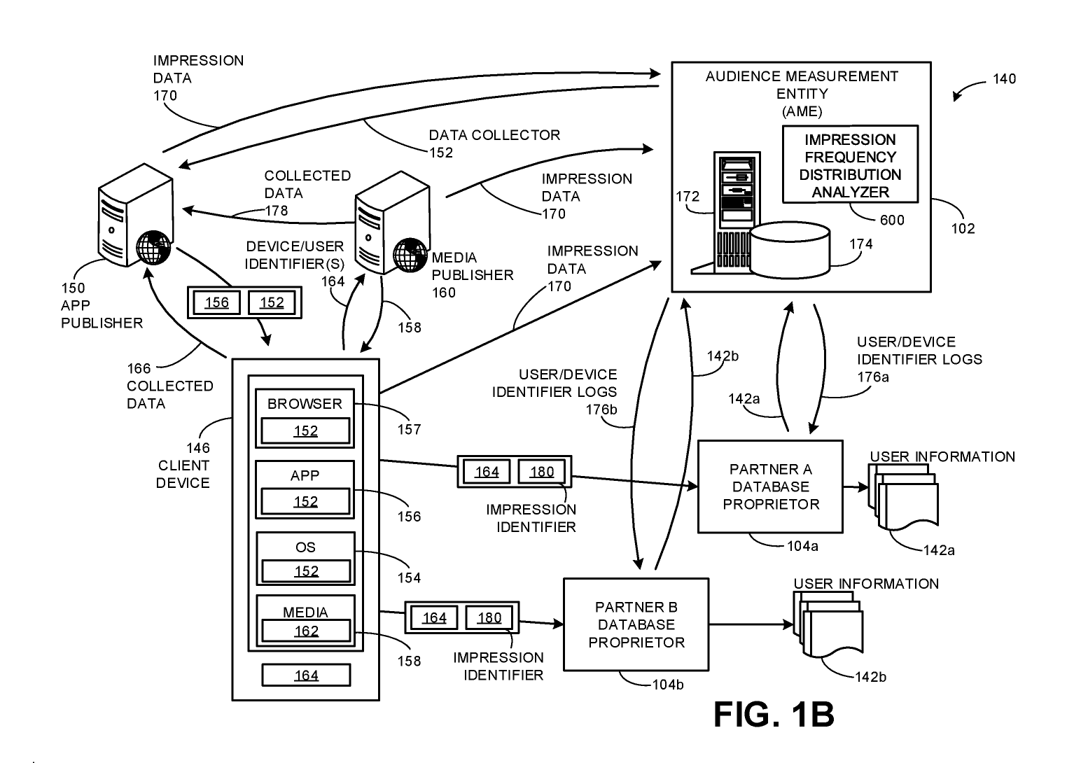

FIG. 1A is an example communication flow diagram 100 of an example manner in which an audience measurement entity (AME) 102 can collect impressions of media accessed on client devices 106 and/or media devices 103. In some examples, the AME 102 includes an example impression frequency distribution analyzer 600 to be implemented by a computer/processor system (e.g., the processor system 1000 of FIG. 10) that may analyze the collected impression data to determine frequency distributions for media impressions across platforms. In some examples, the AME 102 communicates with a database proprietor 104 to collect demographic information associated with audience members exposed to media. Demographic impressions refer to impressions that can be associated with particular individuals for whom specific demographic information is known. The example chain of events shown in FIG. 1A occurs when a client device 106 accesses media 110 for which the client device 106 reports an impression to the AME 102 and/or the database proprietor 104. In some examples, the client device 106 reports impressions for accessed media based on instructions (e.g., beacon instructions) embedded in the media that instruct the client device 106 (e.g., instruct a web browser or an app in the client device 106) to send beacon/impression requests to the AME 102 and/or the database proprietor 104. In such examples, the media having the beacon instructions is referred to as tagged media. In other examples, the client device 106 reports impressions for accessed media based on instructions embedded in apps or web browsers that execute on the client device 106 to send beacon/impression requests to the AME 102 and/or the database proprietor 104 for corresponding media accessed via those apps or web browsers. In any case, the beacon/impression requests include device/user identifiers (IDs) (e.g., AME IDs and/or database proprietor IDs) to allow the corresponding AME 102 and/or the corresponding database proprietor 104 to associate demographic information with resulting logged impressions.

In the illustrated example, the client device 106 accesses media 110 that is tagged with the beacon instructions 112. The beacon instructions 112 cause the client device 106 to send a beacon/impression request 114 to an AME impressions collector 116 when the client device 106 accesses the media 110. For example, a web browser and/or app of the client device 106 executes the beacon instructions 112 in the media 110 which instruct the browser and/or app to generate and send the beacon/impression request 114. In the illustrated example, the client device 106 sends the beacon/impression request 114 using a network communication includes an HTTP (hypertext transfer protocol) request addressed to the URL (uniform resource locator) of the AME impressions collector 116 at, for example, a first internet domain of the AME 102. The beacon/impression request 114 of the illustrated example includes a media identifier 118 (e.g., an identifier that can be used to identify content, an advertisement, and/or any other media) corresponding to the media 110. In some examples, the beacon/impression request 114 also includes a site identifier (e.g., a URL) of the website that served the media 110 to the client device 106 and/or a host website ID (e.g., www.acme.com) of the website that displays or presents the media 110. In the illustrated example, the beacon/impression request 114 includes a device/user identifier 120. In the illustrated example, the device/user identifier 120 that the client device 106 provides to the AME impressions collector 116 in the beacon impression request 114 is an AME ID because it corresponds to an identifier that the AME 102 uses to identify a panelist corresponding to the client device 106. In other examples, the client device 106 may not send the device/user identifier 120 until the client device 106 receives a request for the same from a server of the AME 102 in response to, for example, the AME impressions collector 116 receiving the beacon/impression request 114.

In some examples, the device/user identifier 120 may include a hardware identifier (e.g., an international mobile equipment identity (IMEI), a mobile equipment identifier (MEID), a media access control (MAC) address, etc.), an app store identifier (e.g., a Google Android ID, an Apple ID, an Amazon ID, etc.), a unique device identifier (UDID) (e.g., a non-proprietary UDID or a proprietary UDID such as used on the Microsoft Windows platform), an open source unique device identifier (OpenUDID), an open device identification number (ODIN), a login identifier (e.g., a username), an email address, user agent data (e.g., application type, operating system, software vendor, software revision, etc.), an Ad-ID (e.g., an advertising ID introduced by Apple, Inc. for uniquely identifying mobile devices for the purposes of serving advertising to such mobile devices), an Identifier for Advertisers (IDFA) (e.g., a unique ID for Apple iOS devices that mobile ad networks can use to serve advertisements), a Google Advertising ID, a Roku ID (e.g., an identifier for a Roku OTT device), a third-party service identifier (e.g., advertising service identifiers, device usage analytics service identifiers, demographics collection service identifiers), web storage data, document object model (DOM) storage data, local shared objects (also referred to as “Flash cookies”), and/or any other identifier that the AME 102 stores in association with demographic information about users of the client devices 106. In this manner, when the AME 102 receives the device/user identifier 120, the AME 102 can obtain demographic information corresponding to a user of the client device 106 based on the device/user identifier 120 that the AME 102 receives from the client device 106. In some examples, the device/user identifier 120 may be encrypted (e.g., hashed) at the client device 106 so that only an intended final recipient of the device/user identifier 120 can decrypt the hashed identifier 120. For example, if the device/user identifier 120 is a cookie that is set in the client device 106 by the AME 102, the device/user identifier 120 can be hashed so that only the AME 102 can decrypt the device/user identifier 120. If the device/user identifier 120 is an IMEI number, the client device 106 can hash the device/user identifier 120 so that only a wireless carrier (e.g., the database proprietor 104) can decrypt the hashed identifier 120 to recover the IMEI for use in accessing demographic information corresponding to the user of the client device 106. By hashing the device/user identifier 120, an intermediate party (e.g., an intermediate server or entity on the Internet) receiving the beacon request cannot directly identify a user of the client device 106.

In response to receiving the beacon/impression request 114, the AME impressions collector 116 logs an impression for the media 110 by storing the media identifier 118 contained in the beacon/impression request 114. In the illustrated example of FIG. 1A, the AME impressions collector 116 also uses the device/user identifier 120 in the beacon/impression request 114 to identify AME panelist demographic information corresponding to a panelist of the client device 106. That is, the device/user identifier 120 matches a user ID of a panelist member (e.g., a panelist corresponding to a panelist profile maintained and/or stored by the AME 102). In this manner, the AME impressions collector 116 can associate the logged impression with demographic information of a panelist corresponding to the client device 106.

In some examples, the beacon/impression request 114 may not include the device/user identifier 120 if, for example, the user of the client device 106 is not an AME panelist. In such examples, the AME impressions collector 116 logs impressions regardless of whether the client device 106 provides the device/user identifier 120 in the beacon/impression request 114 (or in response to a request for the identifier 120). When the client device 106 does not provide the device/user identifier 120, the AME impressions collector 116 will still benefit from logging an impression for the media 110 even though it will not have corresponding demographics (e.g., an impression may be collected as a census impression). For example, the AME 102 may still use the logged impression to generate a total impressions count and/or a frequency of impressions (e.g., an impressions frequency) for the media 110. Additionally or alternatively, the AME 102 may obtain demographics information from the database proprietor 104 for the logged impression if the client device 106 corresponds to a subscriber of the database proprietor 104.

In the illustrated example of FIG. 1A, to compare or supplement panelist demographics (e.g., for accuracy or completeness) of the AME 102 with demographics from one or more database proprietors (e.g., the database proprietor 104), the AME impressions collector 116 returns a beacon response message 122 (e.g., a first beacon response) to the client device 106 including an HTTP “302 Found” re-direct message and a URL of a participating database proprietor 104 at, for example, a second internet domain. In the illustrated example, the HTTP “302 Found” re-direct message in the beacon response 122 instructs the client device 106 to send a second beacon request 124 to the database proprietor 104. In other examples, instead of using an HTTP “302 Found” re-direct message, redirects may be implemented using, for example, an iframe source instruction (e.g., <iframe src=“ ”>) or any other instruction that can instruct a client device to send a subsequent beacon request (e.g., the second beacon request 124) to a participating database proprietor 104. In the illustrated example, the AME impressions collector 116 determines the database proprietor 104 specified in the beacon response 122 using a rule and/or any other suitable type of selection criteria or process. In some examples, the AME impressions collector 116 determines a particular database proprietor to which to redirect a beacon request based on, for example, empirical data indicative of which database proprietor is most likely to have demographic data for a user corresponding to the device/user identifier 120. In some examples, the beacon instructions 112 include a predefined URL of one or more database proprietors to which the client device 106 should send follow up beacon requests 124. In other examples, the same database proprietor is always identified in the first redirect message (e.g., the beacon response 122).

In the illustrated example of FIG. 1A, the beacon/impression request 124 may include a device/user identifier 126 that is a database proprietor ID because it is used by the database proprietor 104 to identify a subscriber of the client device 106 when logging an impression. In some instances (e.g., in which the database proprietor 104 has not yet set a database proprietor ID in the client device 106), the beacon/impression request 124 does not include the device/user identifier 126. In some examples, the database proprietor ID is not sent until the database proprietor 104 requests the same (e.g., in response to the beacon/impression request 124). In some examples, the device/user identifier 126 is a device identifier (e.g., an international mobile equipment identity (IMEI), a mobile equipment identifier (MEID), a media access control (MAC) address, etc.), a web browser unique identifier (e.g., a cookie), a user identifier (e.g., a user name, a login ID, etc.), an Adobe Flash® client identifier, identification information stored in an HTML5 datastore, and/or any other identifier that the database proprietor 104 stores in association with demographic information about subscribers corresponding to the client devices 106. When the database proprietor 104 receives the device/user identifier 126, the database proprietor 104 can obtain demographic information corresponding to a user of the client device 106 based on the device/user identifier 126 that the database proprietor 104 receives from the client device 106. In some examples, the device/user identifier 126 may be encrypted (e.g., hashed) at the client device 106 so that only an intended final recipient of the device/user identifier 126 can decrypt the hashed identifier 126. For example, if the device/user identifier 126 is a cookie that is set in the client device 106 by the database proprietor 104, the device/user identifier 126 can be hashed so that only the database proprietor 104 can decrypt the device/user identifier 126. If the device/user identifier 126 is an IMEI number, the client device 106 can hash the device/user identifier 126 so that only a wireless carrier (e.g., the database proprietor 104) can decrypt the hashed identifier 126 to recover the IMEI for use in accessing demographic information corresponding to the user of the client device 106. By hashing the device/user identifier 126, an intermediate party (e.g., an intermediate server or entity on the Internet) receiving the beacon request cannot directly identify a user of the client device 106. For example, if the intended final recipient of the device/user identifier 126 is the database proprietor 104, the AME 102 cannot recover identifier information when the device/user identifier 126 is hashed by the client device 106 for decrypting only by the intended database proprietor 104.

Although only a single database proprietor 104 is shown in FIG. 1A, the impression reporting/collection process of FIG. 1A may be implemented using multiple database proprietors. In some such examples, the beacon instructions 112 cause the client device 106 to send beacon/impression requests 124 to numerous database proprietors. For example, the beacon instructions 112 may cause the client device 106 to send the beacon/impression requests 124 to the numerous database proprietors in parallel or in daisy chain fashion. In some such examples, the beacon instructions 112 cause the client device 106 to stop sending beacon/impression requests 124 to database proprietors once a database proprietor has recognized the client device 106. In other examples, the beacon instructions 112 cause the client device 106 to send beacon/impression requests 124 to database proprietors so that multiple database proprietors can recognize the client device 106 and log a corresponding impression. In any case, multiple database proprietors are provided the opportunity to log impressions and provide corresponding demographics information if the user of the client device 106 is a subscriber of services of those database proprietors.

In some examples, prior to sending the beacon response 122 to the client device 106, the AME impressions collector 116 replaces site IDs (e.g., URLs) of media provider(s) that served the media 110 with modified site IDs (e.g., substitute site IDs) which are discernable only by the AME 102 to identify the media provider(s). In some examples, the AME impressions collector 116 may also replace a host website ID (e.g., www.acme.com) with a modified host site ID (e.g., a substitute host site ID) which is discernable only by the AME 102 as corresponding to the host website via which the media 110 is presented. In some examples, the AME impressions collector 116 also replaces the media identifier 118 with a modified media identifier 118 corresponding to the media 110. In this way, the media provider of the media 110, the host website that presents the media 110, and/or the media identifier 118 are obscured from the database proprietor 104, but the database proprietor 104 can still log impressions based on the modified values which can later be deciphered by the AME 102 after the AME 102 receives logged impressions from the database proprietor 104. In some examples, the AME impressions collector 116 does not send site IDs, host site IDS, the media identifier 118 or modified versions thereof in the beacon response 122. In such examples, the client device 106 provides the original, non-modified versions of the media identifier 118, site IDs, host IDs, etc. to the database proprietor 104.

In the illustrated example, the AME impression collector 116 maintains a modified ID mapping table 128 that maps original site IDs with modified (or substitute) site IDs, original host site IDs with modified host site IDs, and/or maps modified media identifiers to the media identifiers such as the media identifier 118 to obfuscate or hide such information from database proprietors such as the database proprietor 104. Also in the illustrated example, the AME impressions collector 116 encrypts all of the information received in the beacon/impression request 114 and the modified information to prevent any intercepting parties from decoding the information. The AME impressions collector 116 of the illustrated example sends the encrypted information in the beacon response 122 to the client device 106 so that the client device 106 can send the encrypted information to the database proprietor 104 in the beacon/impression request 124. In the illustrated example, the AME impressions collector 116 uses an encryption that can be decrypted by the database proprietor 104 site specified in the HTTP “302 Found” re-direct message.

Periodically or aperiodically, the impression data collected by the database proprietor 104 is provided to a database proprietor impressions collector 130 of the AME 102 as, for example, batch data. In some examples, the impression data may be combined or aggregated to generate a media impression frequency distribution for all individuals exposed to the media 110 that the database proprietor 104 was able to identify (e.g., based on the device/user identifier 126). During a data collecting and merging process to combine demographic and impression data from the AME 102 and the database proprietor(s) 104, impressions logged by the AME 102 for the client devices 106 that do not have a database proprietor ID will not correspond to impressions logged by the database proprietor 104 because the database proprietor 104 typically does not log impressions for the client devices that do not have database proprietor IDs.

Additional examples that may be used to implement the beacon instruction processes of FIG. 1A are disclosed in Mainak et al., U.S. Pat. No. 8,370,489, which is hereby incorporated herein by reference in its entirety. In addition, other examples that may be used to implement such beacon instructions are disclosed in Blumenau, U.S. Pat. No. 6,108,637, which is hereby incorporated herein by reference in its entirety.

In some examples, the AME 102 also collects impression data from a media meter 101 monitoring the media accessed by the media device 103. In the illustrated example, the media device 103 can be any type of media device (e.g., a radio, a television, a mobile phone, a personal computer, a tablet, etc.) that may or may not be capable of executing the beacon instructions 112. In some examples, media meters 101 are provided to audience members enrolled as panelists in an audience measurement panel of the AME 102. Such media meters 101 may be installed in a panelist household to monitor media exposure of the panelist accessed via the client device 106 and/or other media devices 103 in the panelist's household. In other examples, the media meter 101 may be portable and carried by a panelist to monitor exposure to media whether inside or outside of the panelist's household. The media meter 101 may be implemented in other manners to collect media impressions. For example, the media meter 101 may be a return path data (RPD) capable device associated with a media content provider that reports media accessed from the content provider to the AME 102. In some examples, such RPD devices may report media impressions to the content provider, which subsequently provides the data to the AME 102.

FIG. 1B depicts an example system 142 to collect impression information based on user information 142a, 142b from distributed database proprietors 104 (designated as 104a and 104b in FIG. 1B) for associating with impressions of media presented at a client device 146. In the illustrated examples, user information 142a, 142b or user data includes one or more of demographic data, purchase data, and/or other data indicative of user activities, behaviors, and/or preferences related to information accessed via the Internet, purchases, media accessed on electronic devices, physical locations (e.g., retail or commercial establishments, restaurants, venues, etc.) visited by users, etc. Thus, the user information 142a, 142b may indicate and/or be analyzed to determine the impression frequency of individual users with respect to different media accessed by the users. In some examples, such impression information, combined with that collected from media monitors 101 (FIG. 1A), may be combined or aggregated to generate a media impression frequency distribution for all users exposed to particular media for whom the database proprietor has particular user information 142a, 142b. More particularly, in the illustrated example of FIG. 1B, the AME 102 includes the example impression frequency distribution analyzer 600 to analyze the collected impression data to determine frequency distributions for media impressions as described more fully below.

In the illustrated example of FIG. 1B, the client device 146 may be a mobile device (e.g., a smart phone, a tablet, etc.), an internet appliance, a smart television, an internet terminal, a computer, or any other device capable of presenting media received via network communications. In some examples, to track media impressions on the client device 146, an audience measurement entity (AME) 102 partners with or cooperates with an app publisher 150 to download and install a data collector 152 on the client device 146. The app publisher 150 of the illustrated example may be a software app developer that develops and distributes apps to mobile devices and/or a distributor that receives apps from software app developers and distributes the apps to mobile devices. The data collector 152 may be included in other software loaded onto the client device 146, such as the operating system 154, an application (or app) 156, a web browser 117, and/or any other software.

Any of the example software 154, 156, 117 may present media 158 received from a media publisher 160. The media 158 may be an advertisement, video, audio, text, a graphic, a web page, news, educational media, entertainment media, or any other type of media. In the illustrated example, a media ID 162 is provided in the media 158 to enable identifying the media 158 so that the AME 102 can credit the media 158 with media impressions when the media 158 is presented on the client device 146 or any other device that is monitored by the AME 102.

The data collector 152 of the illustrated example includes instructions (e.g., Java, java script, or any other computer language or script) that, when executed by the client device 146, cause the client device 146 to collect the media ID 162 of the media 158 presented by the app program 156, the browser 117, and/or the client device 146, and to collect one or more device/user identifier(s) 164 stored in the client device 146. The device/user identifier(s) 164 of the illustrated example include identifiers that can be used by corresponding ones of the partner database proprietors 104a-b to identify the user or users of the client device 146, and to locate user information 142a-b corresponding to the user(s). For example, the device/user identifier(s) 164 may include hardware identifiers (e.g., an international mobile equipment identity (IMEI), a mobile equipment identifier (MEID), a media access control (MAC) address, etc.), an app store identifier (e.g., a Google Android ID, an Apple ID, an Amazon ID, etc.), a unique device identifier (UDID) (e.g., a non-proprietary UDID or a proprietary UDID such as used on the Microsoft Windows platform), an open source unique device identifier (OpenUDID), an open device identification number (ODIN), a login identifier (e.g., a username), an email address, user agent data (e.g., application type, operating system, software vendor, software revision, etc.), an Ad-ID (e.g., an advertising ID introduced by Apple, Inc. for uniquely identifying mobile devices for the purposes of serving advertising to such mobile devices), an Identifier for Advertisers (IDFA) (e.g., a unique ID for Apple iOS devices that mobile ad networks can use to serve advertisements), a Google Advertising ID, a Roku ID (e.g., an identifier for a Roku OTT device), third-party service identifiers (e.g., advertising service identifiers, device usage analytics service identifiers, demographics collection service identifiers), web storage data, document object model (DOM) storage data, local shared objects (also referred to as “Flash cookies”), etc. In examples in which the media 158 is accessed using an application and/or browser (e.g., the app 156 and/or the browser 117) that do not employ cookies, the device/user identifier(s) 164 are non-cookie identifiers such as the example identifiers noted above. In examples in which the media 158 is accessed using an application or browser that does employ cookies, the device/user identifier(s) 164 may additionally or alternatively include cookies. In some examples, fewer or more device/user identifier(s) 164 may be used. In addition, although only two partner database proprietors 104a-b are shown in FIG. 1, the AME 102 may partner with any number of partner database proprietors to collect distributed user information (e.g., the user information 142a-b).

In some examples, the client device 146 may not allow access to identification information stored in the client device 146. For such instances, the disclosed examples enable the AME 102 to store an AME-provided identifier (e.g., an identifier managed and tracked by the AME 102) in the client device 146 to track media impressions on the client device 146. For example, the AME 102 may provide instructions in the data collector 152 to set an AME-provided identifier in memory space accessible by and/or allocated to the app program 156 and/or the browser 117, and the data collector 152 uses the identifier as a device/user identifier 164. In such examples, the AME-provided identifier set by the data collector 152 persists in the memory space even when the app program 156 and the data collector 152 and/or the browser 117 and the data collector 152 are not running. In this manner, the same AME-provided identifier can remain associated with the client device 146 for extended durations. In some examples in which the data collector 152 sets an identifier in the client device 146, the AME 102 may recruit a user of the client device 146 as a panelist, and may store user information collected from the user during a panelist registration process and/or collected by monitoring user activities/behavior via the client device 146 and/or any other device used by the user and monitored by the AME 102. In this manner, the AME 102 can associate user information of the user (from panelist data stored by the AME 102) with media impressions attributed to the user on the client device 146. As used herein, a panelist is a user registered on a panel maintained by a ratings entity (e.g., the AME 102) that monitors and estimates audience exposure to media.

In the illustrated example, the data collector 152 sends the media ID 162 and the one or more device/user identifier(s) 164 as collected data 166 to the app publisher 150. Alternatively, the data collector 152 may be configured to send the collected data 166 to another collection entity (other than the app publisher 150) that has been contracted by the AME 102 or is partnered with the AME 102 to collect media ID's (e.g., the media ID 162) and device/user identifiers (e.g., the device/user identifier(s) 164) from user devices (e.g., the client device 146). In the illustrated example, the app publisher 150 (or a collection entity) sends the media ID 162 and the device/user identifier(s) 164 as impression data 170 to an impression collector 172 (e.g., an impression collection server or a data collection server) at the AME 102. The impression data 170 of the illustrated example may include one media ID 162 and one or more device/user identifier(s) 164 to report a single impression of the media 158, or it may include numerous media ID's 162 and device/user identifier(s) 164 based on numerous instances of collected data (e.g., the collected data 166) received from the client device 146 and/or other devices to report multiple impressions of media.

In the illustrated example, the impression collector 172 stores the impression data 170 in an AME media impressions store 174 (e.g., a database or other data structure). Subsequently, the AME 102 sends the device/user identifier(s) 164 to corresponding partner database proprietors (e.g., the partner database proprietors 104a-b) to receive user information (e.g., the user information 142a-b) corresponding to the device/user identifier(s) 164 from the partner database proprietors 104a-b so that the AME 102 can associate the user information with corresponding media impressions of media (e.g., the media 158) presented at the client device 146.

More particularly, in some examples, after the AME 102 receives the device/user identifier(s) 164, the AME 102 sends device/user identifier logs 176a-b to corresponding partner database proprietors (e.g., the partner database proprietors 104a-b). Each of the device/user identifier logs 176a-b may include a single device/user identifier 164, or it may include numerous aggregate device/user identifiers 164 received over time from one or more devices (e.g., the client device 146). After receiving the device/user identifier logs 176a-b, each of the partner database proprietors 104a-b looks up its users corresponding to the device/user identifiers 164 in the respective logs 176a-b. In this manner, each of the partner database proprietors 104a-b collects user information 142a-b corresponding to users identified in the device/user identifier logs 176a-b for sending to the AME 102. For example, if the partner database proprietor 104a is a wireless service provider and the device/user identifier log 176a includes IMEI numbers recognizable by the wireless service provider, the wireless service provider accesses its subscriber records to find users having IMEI numbers matching the IMEI numbers received in the device/user identifier log 176a. When the users are identified, the wireless service provider copies the users' user information to the user information 142a for delivery to the AME 102.

In some other examples, the data collector 152 is configured to collect the device/user identifier(s) 164 from the client device 146. The example data collector 152 sends the device/user identifier(s) 164 to the app publisher 150 in the collected data 166, and it also sends the device/user identifier(s) 164 to the media publisher 160. In such other examples, the data collector 152 does not collect the media ID 162 from the media 158 at the client device 146 as the data collector 152 does in the example system 142 of FIG. 1B. Instead, the media publisher 160 that publishes the media 158 to the client device 146 retrieves the media ID 162 from the media 158 that it publishes. The media publisher 160 then associates the media ID 162 to the device/user identifier(s) 164 received from the data collector 152 executing in the client device 146, and sends collected data 178 to the app publisher 150 that includes the media ID 162 and the associated device/user identifier(s) 164 of the client device 146. For example, when the media publisher 160 sends the media 158 to the client device 146, it does so by identifying the client device 146 as a destination device for the media 158 using one or more of the device/user identifier(s) 164 received from the client device 146. In this manner, the media publisher 160 can associate the media ID 162 of the media 158 with the device/user identifier(s) 164 of the client device 146 indicating that the media 158 was sent to the particular client device 146 for presentation (e.g., to generate an impression of the media 158).

In some other examples in which the data collector 152 is configured to send the device/user identifier(s) 164 to the media publisher 160, the data collector 152 does not collect the media ID 162 from the media 158 at the client device 146. Instead, the media publisher 160 that publishes the media 158 to the client device 146 also retrieves the media ID 162 from the media 158 that it publishes. The media publisher 160 then associates the media ID 162 with the device/user identifier(s) 164 of the client device 146. The media publisher 160 then sends the media impression data 170, including the media ID 162 and the device/user identifier(s) 164, to the AME 102. For example, when the media publisher 160 sends the media 158 to the client device 146, it does so by identifying the client device 146 as a destination device for the media 158 using one or more of the device/user identifier(s) 164. In this manner, the media publisher 160 can associate the media ID 162 of the media 158 with the device/user identifier(s) 164 of the client device 146 indicating that the media 158 was sent to the particular client device 146 for presentation (e.g., to generate an impression of the media 158). In the illustrated example, after the AME 102 receives the impression data 170 from the media publisher 160, the AME 102 can then send the device/user identifier logs 176a-b to the partner database proprietors 104a-b to request the user information 142a-b as described above.

Although the media publisher 160 is shown separate from the app publisher 150 in FIG. 1, the app publisher 150 may implement at least some of the operations of the media publisher 160 to send the media 158 to the client device 146 for presentation. For example, advertisement providers, media providers, or other information providers may send media (e.g., the media 158) to the app publisher 150 for publishing to the client device 146 via, for example, the app program 156 when it is executing on the client device 146. In such examples, the app publisher 150 implements the operations described above as being performed by the media publisher 160.

Additionally or alternatively, in contrast with the examples described above in which the client device 146 sends identifiers to the audience measurement entity 102 (e.g., via the application publisher 150, the media publisher 160, and/or another entity), in other examples the client device 146 (e.g., the data collector 152 installed on the client device 146) sends the identifiers (e.g., the device/user identifier(s) 164) directly to the respective database proprietors 104a, 104b (e.g., not via the AME 102). In such examples, the example client device 146 sends the media identifier 162 to the audience measurement entity 102 (e.g., directly or through an intermediary such as via the application publisher 150), but does not send the media identifier 162 to the database proprietors 104a-b.

As mentioned above, the example partner database proprietors 104a-b provide the user information 142a-b to the example AME 102 for matching with the media identifier 162 to form media impression information. As also mentioned above, the database proprietors 104a-b are not provided copies of the media identifier 162. Instead, the client provides the database proprietors 104a-b with impression identifiers 180. An impression identifier uniquely identifies an impression event relative to other impression events of the client device 146 so that an occurrence of an impression at the client device 146 can be distinguished from other occurrences of impressions. However, the impression identifier 180 does not itself identify the media associated with that impression event. In such examples, the impression data 170 from the client device 146 to the AME 102 also includes the impression identifier 180 and the corresponding media identifier 162. To match the user information 142a-b with the media identifier 162, the example partner database proprietors 104a-b provide the user information 142a-b to the AME 102 in association with the impression identifier 180 for the impression event that triggered the collection of the user information 142a-b. In this manner, the AME 102 can match the impression identifier 180 received from the client device 146 to a corresponding impression identifier 180 received from the partner database proprietors 104a-b to associate the media identifier 162 received from the client device 146 with demographic information in the user information 142a-b received from the database proprietors 104a-b. The impression identifier 180 can additionally be used for reducing or avoiding duplication of demographic information. For example, the example partner database proprietors 104a-b may provide the user information 142a-b and the impression identifier 180 to the AME 102 on a per-impression basis (e.g., each time a client device 146 sends a request including an encrypted identifier 164a-b and an impression identifier 180 to the partner database proprietor 104a-b) and/or on an aggregated basis (e.g., send a set of user information 142a-b, which may include indications of multiple impressions (e.g., multiple impression identifiers 180), to the AME 102 presented at the client device 146).

The impression identifier 180 provided to the AME 102 enables the AME 102 to distinguish unique impressions and avoid over counting a number of unique users and/or devices viewing the media. For example, the relationship between the user information 142a from the partner A database proprietor 104a and the user information 142b from the partner B database proprietor 104b for the client device 146 is not readily apparent to the AME 102. By including an impression identifier 180 (or any similar identifier), the example AME 102 can associate user information corresponding to the same user between the user information 142a-b based on matching impression identifiers 180 stored in both of the user information 142a-b. The example AME 102 can use such matching impression identifiers 180 across the user information 142a-b to avoid over counting mobile devices and/or users (e.g., by only counting unique users instead of counting the same user multiple times).

A same user may be counted multiple times if, for example, an impression causes the client device 146 to send multiple device/user identifiers to multiple different database proprietors 104a-b without an impression identifier (e.g., the impression identifier 180). For example, a first one of the database proprietors 104a sends first user information 142a to the AME 102, which signals that an impression occurred. In addition, a second one of the database proprietors 104b sends second user information 142b to the AME 102, which signals (separately) that an impression occurred. In addition, separately, the client device 146 sends an indication of an impression to the AME 102. Without knowing that the user information 142a-b is from the same impression, the AME 102 has an indication from the client device 146 of a single impression and indications from the database proprietors 104a-b of multiple impressions.

To avoid over counting impressions, the AME 102 can use the impression identifier 180. For example, after looking up user information 142a-b, the example partner database proprietors 104a-b transmit the impression identifier 180 to the AME 102 with corresponding user information 142a-b. The AME 102 matches the impression identifier 180 obtained directly from the client device 146 to the impression identifier 180 received from the database proprietors 104a-b with the user information 142a-b to thereby associate the user information 142a-b with the media identifier 162 and to generate impression information. This is possible because the AME 102 received the media identifier 162 in association with the impression identifier 180 directly from the client device 146. Therefore, the AME 102 can map user data from two or more database proprietors 104a-b to the same media exposure event, thus avoiding double counting.

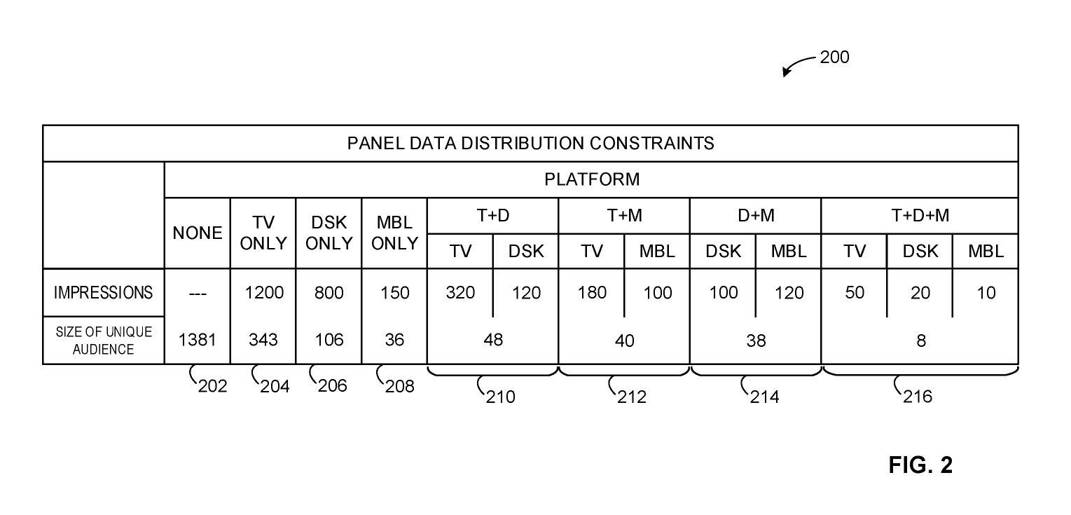

In the illustrated examples of FIGS. 1A and/or 1B the impression frequency distribution analyzer 600 receives media exposure data, including unique audience size and impression count data, from media monitors 101. With this collected data, the impression frequency distribution analyzer 600, by applying the principles of maximum entropy and minimum cross entropy, then develops estimated probability distributions of both panel probability distributions and census probability distributions. In some examples, the impression frequency distribution analyzer 600 uses the data gathered by the media monitors 101 and/or any other mechanism, to constrain the panel probability distribution the analyzer 600 estimates. This aggregation of impression data may be represented or stored in an example data structure similar to example table 200, as shown in FIG. 2. In particular, example table 200 provides the numbers of unique audience member panelists associated with the number of impressions of media corresponding to particular platforms and/or combinations of platforms. For example, in the TV only column 204, there are 1200 logged impressions attributable to 343 unique audience member panelists. That is, each of the 343 panelists contributed to least one impression via a television. In the example table 200, the columns 202-216 represent disjoint combinations of platforms meaning that impressions in each column correspond to a panelist exposed to media only through the platform or combination of platforms designated in each column. As used herein, “disjoint” means there are no common elements (e.g., as between two or more sets of data). For example, “disjoint combinations of platforms” means that each combination of platforms contains separate and unique individual platforms not included in any other combinations of platforms. Similarly, the unique audience sizes and corresponding impressions counts for any particular combination of platforms may also be referred to as “disjoint” when the audience members associated with the unique audience size (and associated impressions) for each platform combination are mutually exclusive of audience members associated with the other platform combinations. Thus, associating the 343 unique audience member panelists to the TV only column 204 indicates that the 343 panelists were not exposed to the particular media being analyzed via either a mobile device or a desktop device. If a panelist was exposed to the media via television and contributed to at least one impression on a mobile device but no impressions via a desktop computer, the panelist would be grouped in the T+M column 212. In other words, each panelist is identified in one and only one column. As a result, summing the unique audience size in every column (including the no impressions column 202) provides the total population of audience members for the data being represented.

As can be seen from FIG. 2, there are more impressions in any particular column than there are unique audience member panelists in each column. For example, in the DSK only column 206, there are 800 impressions but only 106 unique audience members. This indicates that at least some of the 106 unique audience members had more than one corresponding impression via a desktop computer. Thus, the particular number of impressions (e.g., the impression frequency) corresponding to any particular audience member is not represented in table 200. However, insomuch as the data represented in table 200 is based on panelist data collected by the AME, such frequencies are available.

Similarly, in the platform combination columns 210, 212, 214 and 216, the sum of the impressions for each platform combination is larger than the size of the unique audience for that platform combination. For example, in the D+M column 214, there are a total of 220 impressions (100 on DSK+120 on MBL) but only 38 unique audience members. This indicates that at least some of the 38 unique audience members had more than one impression via desktop computer and that at least some of 38 audience members had more than one corresponding impression via a mobile phone.

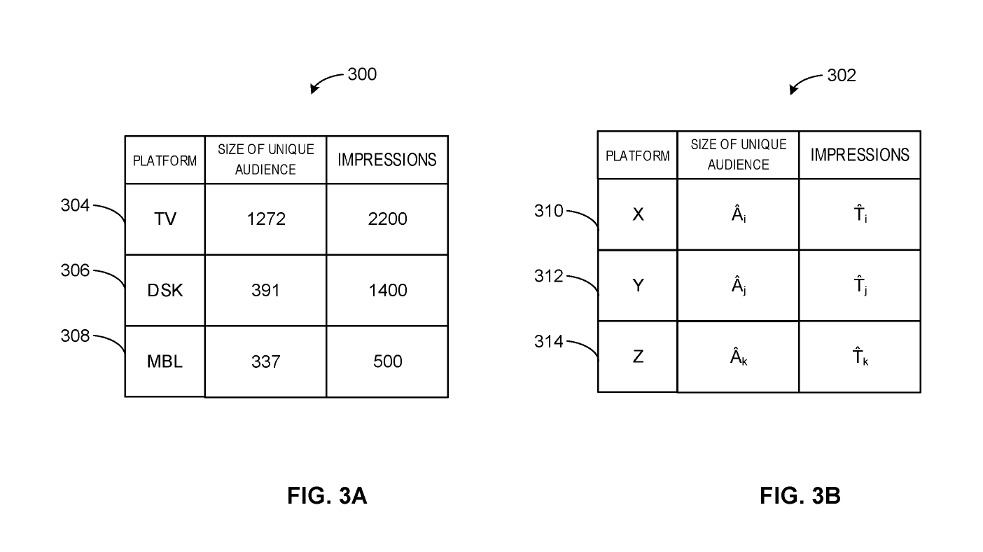

In the illustrated examples of FIGS. 1A and/or 1B the impression frequency distribution analyzer 600 receives census level media exposure data, including unique audience size and impression count data, from database proprietors 104. The analyzer 600 uses this gathered data, along with the gathered panel data and principle of cross entropy to develop census probability distributions. The aggregation of census impression data may be represented or stored in an example data structure similar to example table 300, as shown in FIG. 3A.

In contrast to media impression data and associated frequencies for panelists, disjoint audience and impression data for non-panelists cannot be directly determined. Furthermore, unlike for panel data, non-panelist impression data (e.g., census data) does not typically account for the overlap of audience members across different platforms. In some examples, the AME 102 may receive an indication of overlap between the different types of digital platforms (e.g., the mobile platform and the desktop platform) from the partnered database proprietor 104. For example, in the case where no such overlap metric is received (e.g., with respect to the TV platform), in the TV row 304 of FIG. 3 there are a total of 2200 impressions via a TV corresponding to 1272 audience members. Beyond these total values for impressions and unique audience sizes (associated with each particular platform), there is no direct way to determine whether any of the audience members were also exposed to media via other platforms (e.g., these values are not disjoint from one another). For example, in the TV row 304, the DSK row 306 and the MBL row 308 there is a unique audience size of 1272, 391 and 337 corresponding to each platform, respectively. While the audience members associated with any one platform are unique (e.g., non-duplicative) with respect to that platform, these audience members may or may not be unique with respect to audience members counted in the audience size corresponding to a different one of the platforms. For example, the 337 MBL audience members may also have some or all of its audience members counted in the 1272 TV audience members, in the 391 DSK audience members or, both the TV and DSK audiences. Without additional information or analysis, overlap of these audiences cannot be determined.

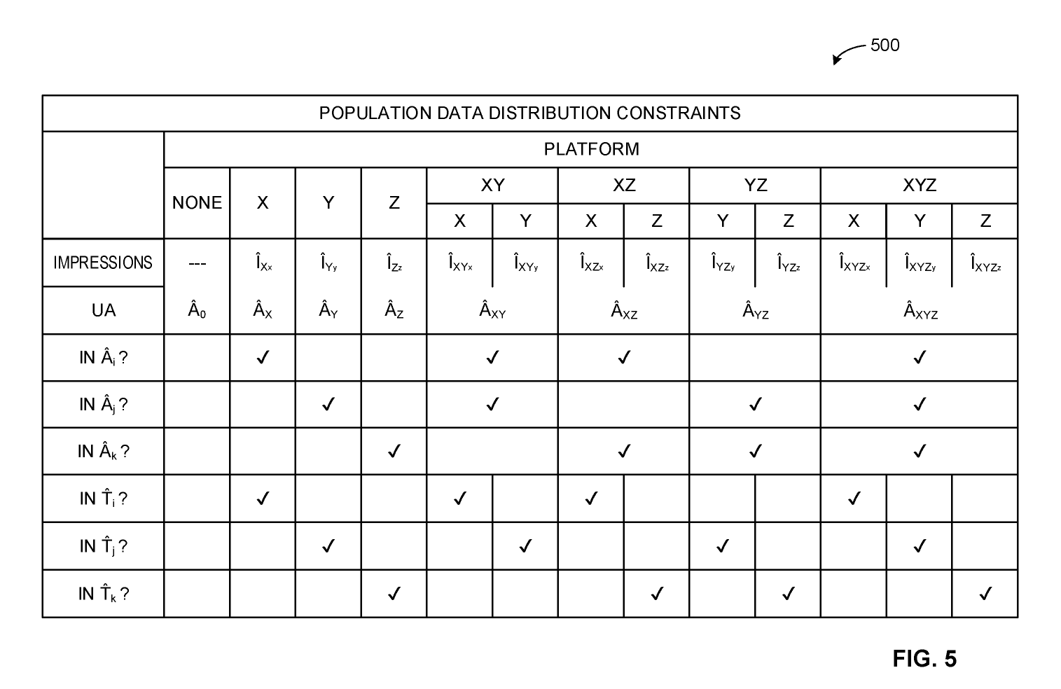

Similarly, there is no direct way to determine the frequency distribution of the impressions to predict how many times any particular audience member was exposed to particular media. Examples disclosed herein overcome these limitations by using census-level audience measurement data (referred to herein as census data for short) in conjunction with panel-level audience measurement data (referred to herein as panel data for short) to estimate values for a table similar to table 200 of FIG. 2. An example of this type of table is illustrated in table 500 of FIG. 5. Further, some examples estimate an impression frequency distribution for the census-level data across the different platforms being analyzed.

For purposes of explanation, FIG. 3B depicts an example table 302 that generically shows the relationship between different platforms X, Y and Z and the gathered census unique audience size and impression count data (e.g., census data) associated with them in a similar manner to table 300 of FIG. 3A. The unique audience size and impression count variables associated with platforms X, Y and, Z are shown in rows 310, 312 and 314 respectively. In some examples, X, Y and, Z may correspond to television, desktop and mobile platforms, respectively. Other examples may include additional and/or different platforms and/or group the data in other ways. Each variable contained in the example table 302 represents a different constraint used in the estimation of the census probability distribution. As used herein, for three platforms X, Y and Z, the 6 constraints (Âᵢ, Âⱼ, Âₖ, \hat{T}ᵢ, \hat{T}ⱼ, and \hat{T}ₖ) and a seventh constraint representing audience members who had no impressions on any platform (Â₀) will be called the “marginal constraints.”

For three platforms X, Y, and Z, the marginal unique audience size data for each platform is referred to as Âᵢ, Âⱼ and Âₖ, respectively, and marginal census impression count data is referred to as \hat{T}ᵢ, \hat{T}ⱼ and \hat{T}ₖ, respectively. As discussed in conjunction with FIG. 3A, the audience sizes represented in the marginal audience constraints may or may not be disjoint from each other because the same audience members counted for one platform may also be counted for a different platform. For example, Âᵢ and Âⱼ both include audience members corresponding to impressions on both platforms X and Y. That is to say, if some audience members had impressions on both X and Y, Âᵢ and Âⱼ share those audience members and therefore, Âᵢ and Âⱼ are not disjoint from one another. Due to the jointed natures of the gathered marginal data sets, they cannot be treated independently during an estimation of the census probability distribution.

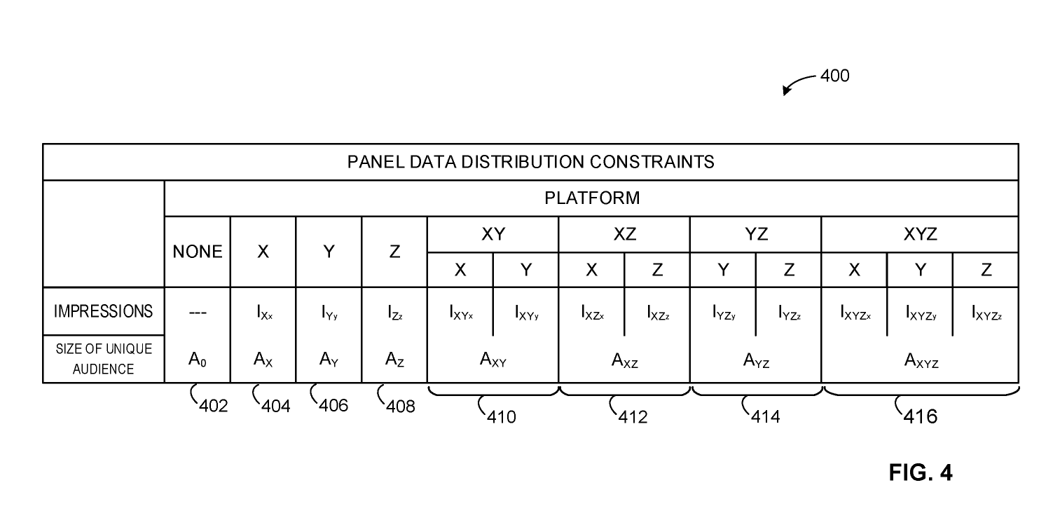

For purposes of explanation, FIG. 4 depicts an example table 400 that generically shows the relationship between different platforms X, Y, and Z and the panel unique audience size and impression count data (e.g., panel data) associated with them in a similar manner to table 200 of FIG. 2. In some examples, X, Y and Z may correspond to television, desktop and mobile platforms, respectively. Other examples, may include other platforms and/or group the data in other ways. Each variable contained within example table 400 represents a constraint used when calculating a specific panel probability distribution (Q). As illustrated in FIGS. 1A and 1B, these constraints are populated by collecting data from a pool of preselected audience members that have enrolled as panelists. The method for estimating the census probability distribution, described herein, requires that this information be known by the AME 102 before preforming the method.

Example table 400 contains 20 values representing collected panel data. These audience and impression segments of the collected panel data constrain the panel probability distribution, Q, and will be referred to herein as panel constraints (including, more particularly, audience constraints and impression constraints). The audience constraints (A), are the unique audience sizes that were exposed to media exclusively via the corresponding platform or combination of platforms. For example, A_{X} refers to the unique audience size corresponding to impressions only on platform X, and A_{XY} refers to the unique audience size corresponding to impressions on both platform X and platform Y but no other platforms. Panelists that had no impressions of the relevant media are part of audience constraint A₀. Thus, each panel audience constraint is disjoint from the others such that each panelist is represented in one, and only one, audience constraint. Impression constraints (I) use two subscripts and represent the impression count corresponding to all audience members collectively within a particular audience constraint corresponding to a particular platform or platform combination. The first subscripts (indicated in capital letters) identify the associated platform or platform combination while the second subscripts (indicated by lower case letters) identify the particular platform through which the associated impressions occurred. For example, I_{XYx} is the impression count on Platform X corresponding to audience members exposed to media via both platform X and platform Y but not platform Z (e.g., corresponding to audience constraint A_{XY}). Additionally, while each member of a particular audience has at least one impression on each relevant platform, the distribution of those impressions between different audience members is unlikely to be even. For example, among panelists associated with the audience constraint A_{xz}, one panelist may have been exposed to the media once via platform X and many times via platform Z while another panelist may have been exposed only once via platform Z and many times via platform X. Each panel impression constraint is disjoint. That is each impression is counted in one and only one constraint.

As shown in the illustrated example, for three platforms, X, Y, and Z, there are 8 audience constraints (e.g., A₀, A_{X}, A_{Y}, A_{Z}, A_{XY}, A_{XZ}, A_{YZ}, A_{XYZ}) and 12 impression constraints (e.g., I_{Xx}, I_{Yy}, I_{Zz}, I_{XYx}, I_{XYy}, I_{XZx}, I_{XZz}, I_{YZy}, I_{YZz}, I_{XYZx}, I_{XYZy}, I_{XYZz}). These values define 20 constraints used to calculate a panel probability distribution representative of the panel data based on the principle of maximum entropy. Referring to equation (2), the constraints values represented in example table 400 are the known values, namely the matrix on the left-hand side and the vector on the right-hand side.

FIG. 5 depicts an example table 500 that shows the relationship between different platforms X, Y, and Z and the census audience and impression data associated with them. Unlike the data contained in tables 200 and 400, this information is not directly known by the AME 102 based on the collected census data. Instead, the method and apparatus disclosed herein estimate the variables contained within the example table 500. To distinguish the variables contained within table 500 from those in table 400, audience and impression data on the census level (e.g., including all audience members within the population of interest) will be notated with a circumflex (̂).

Example table 500 also contains 20 values representing collected census data. These values are to be derived from the census probability distribution, P. Additionally, to avoid confusion, indirectly gathered census data is notated with different subscripts. As discussed in further detail later, these data sets can be expressed by similar terms as those for panel data (e.g., same notation and meaning except applied to the census instead of just the panel). As used herein, these 20 values are referred to as the “partitioned census terms.” For example, Âᵢ can be expressed as the sum of Â_{X}, Â_{XY}, Â_{XZ} and, Â_{XYZ} as each of these partitioned census terms contain audience members corresponding to impressions on platform X. As will be disclosed below, determining the overlap between the gathered data sets allows for the estimation of the census probability distribution P. Additionally, the left hand side of this table shows the relationship between the marginal constraints (e.g., Âᵢ, Âⱼ, \hat{T}ⱼ, and \hat{T}ₖ) and the desired partitioned census terms (Â_{X} and Î_{YZz}). These example relationships are described mathematically in example equation set (24).

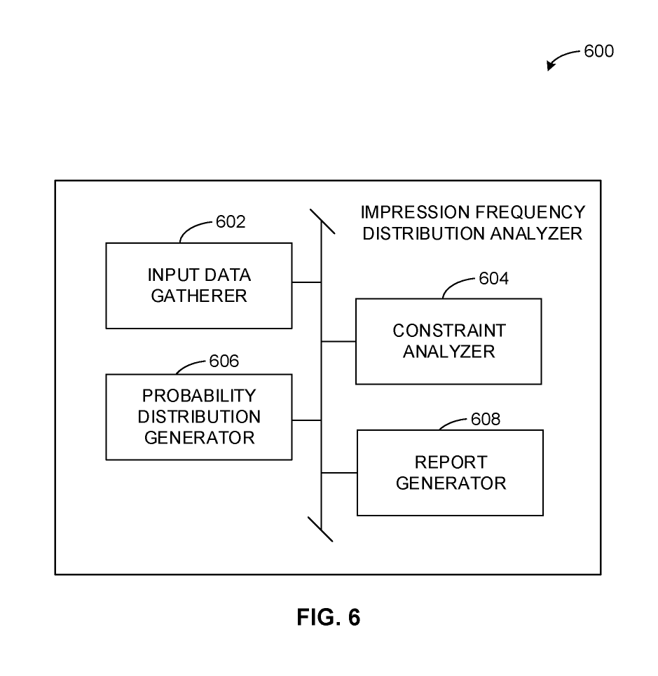

Each of these 20 unknown values contained within example table 500 corresponds to a known panel value in table 400. For example, Â_{X} and Î_{YZz} from table 500 corresponds to variables A_{X} and I_{YZz} in table 400. As described in detail below in FIG. 6 correspondence is defined by a dynamically calculated multiplier that scales the values from table 200 to table 400. In some examples, these multipliers are derived using the method Lagrange multipliers and based in the principles of minimum cross entropy.

FIG. 6 is a block diagram illustrating an example implementation of an example impression frequency distribution analyzer 600. The example analyzer 600 includes an example input data gatherer 602, an example constraint analyzer 604, an example probability distribution generator 606 and an example report generator 608.

The example input data gatherer 602 receives panel data indicative of the number of impressions of media associated with different audience member panelists within a particular population of interest and the accessed platforms by which the audience member panelists accessed the media. Further, the input data gatherer 602 receives census data indicative of the number of impressions of the media associated with audience members within the particular population of interest whose identity is unknown based on the census data. Some of the audience members associated with the census data may be audience member panelists included in the panel data. However, many of the audience members associated with the census data are likely to be non-panelist audience members.

The example constraint analyzer 604 analyzes the panel data and the census data collected by the input data gatherer 602. In the illustrated example, the constraint analyzer 604 groups the panel data impressions and associated unique audience size based on platforms or combinations of platforms through which the panelist audience members accessed the media corresponding to each impression. In some examples, the constraint analyzer 604 may format the grouped data as represented in the example table 400 of FIG. 4. Additionally or alternatively, the grouped data may be stored in other suitable tables, data structures, or formats. In some examples, the panel data is received by the input data gatherer 602 in a form already grouped for subsequent analysis (e.g., the data has already been parsed into the constraints described above). Further, the example constraint analyzer 604 may group the census data impressions and the associated audience members based on the platform through which each impression of the media was accessed. In some examples, the constraint analyzer 604 may format the grouped data as represented in the example table 302 of FIG. 3. As described above, such data may be represented as total values via each platform for which data is available because the overlap of audience members across the different platforms cannot be directly determined from the collected census data.

In some examples, the probability distribution generator 606 defines a panel probability distribution for the panel based on the grouped panel data using the principle of maximum entropy. In particular, for impressions associated with audience members accessing media through one and only one platform, (e.g., only platform X, corresponding to column 404 in FIG. 4), the principle of maximum entropy can be used to show that the most accurate estimation for the panel probability distribution, Q, is one where the entropy, ‘H’, is maximized as expressed in equation (1). Calculating the distribution for the panel data may be accomplished based on the process described in example equations (1)-(5) except that rather than limiting the distribution Q to four probabilities (q₁, q₂, q₃ and q₄), examples disclosed herein assume a distribution with infinite probabilities (e.g., q₁, q₂, q₃ . . . q_{∞}). Modifying equation (1), this can be expressed as the following equation:

$${maximize}_{Q} H ( Q ) = - {\sum }_{i = 1}^{∞} {q}_{\{ i 00 \}} log ( {q}_{\{ i 00 \}} ) \qquad ( 11 )$$

where H(Q) is entropy as a function of the panel probability distribution and q_{{i}} is the ith probability of the panel probability distribution Q. That is, the panel probability distribution, Q, is represented as a one-dimensional array of corresponding probabilities q_{{i}}. Equation (1), which is for one platform, is subject to the following constraints:

Σᵢ₌₁^{∞}q_{{i00}}=A_{X} (12a)

Σᵢ₌₁^{∞}iq_{{i00}}=I_{Xx} (12b)

where Aₓ and I_{Xx} are the unique panel audience size and corresponding impression count data associated with platform X as defined in the X only column 404 of the table 400 and q_{{i00}} is the ith probability in the panel probability distribution Q. As described above in connection with equation (1)-(5), these are the individual probabilities qᵢ for the panel probability distribution ‘Q’ that satisfy the principle of maximum entropy. These individual elements q₁ can also be expressed as the product of exponential Lagrange multipliers consistent with the definition given in equation (4):

q_{{i00}}=z₁z₂⁽ⁱ⁾ (13)

where z₁ is a multiplier corresponding to the exponential constant (i.e., Euler's number) raised to a first Lagrange multiplier associated with the first constraint defined in equation (12a) and z₂ is a multiplier corresponding to the exponential constant raised to a second Lagrange multiplier associated with the second constraint defined in equation (12b). By substituting example equation (13), into example equation set (12) and simplifying using the solution to a geometric series, the following equations can be found:

$$\begin{matrix}{\sum }_{i = 1}^{∞} {q}_{\{ i 00 \}} = {\sum }_{i = 1}^{∞} {z}_{1} {z}_{2}^{( i )} = \frac{{z}_{1} {z}_{2}}{1 - {z}_{2}} = {A}_{X} & ( 14 a ) \\ {\sum }_{i = 1}^{∞} {iq}_{\{ i 00 \}} = {\sum }_{i = 1}^{∞} {z}_{1} {z}_{2}^{( i )} = \frac{{z}_{1} {z}_{2}}{{( 1 - {z}_{2} )}^{2}} = {I}_{Xx} & ( 14 b )\end{matrix}$$

Solving for ‘z₁’ and ‘z₂’ yields:

$$\begin{matrix}{z}_{1} = \frac{{A}_{X}^{2}}{{I}_{Xx} - {A}_{X}} & ( 15 a ) \\ {z}_{2} = 1 - \frac{{A}_{X}}{{I}_{Xx}} & ( 15 b )\end{matrix}$$

Substituting example equation set (15) into example equation (13) yields:

$${q}_{\{ i 00 \}} = {z}_{1} {z}_{2}^{( i )} = ( \frac{{A}_{X}^{2}}{{I}_{Xx} - {A}_{X}} ) {( 1 - \frac{{A}_{X}}{{I}_{Xx}} )}^{i} = {A}_{X} ( \frac{{A}_{X}}{{I}_{Xx}} ) {( 1 - \frac{{A}_{X}}{{I}_{Xx}} )}^{i - 1} \qquad ( 16 a )$$

Thus, in some examples, the probability distribution generator 606 evaluates example equation (16a) for all values of q to define the panel probability distribution Q, limited to a single platform, Thus, when the panel probability distribution is desired for impressions associated with audience members that accessed media via one and only one platform, equation (16) can be evaluated to define the distribution. The notation of the variables in example equation (16) is defined with respect to platform X and the corresponding constraints Aₓ and I_{Xx} represented in the X only column 404 of FIG. 4. A similar equation for platform Y may be generating by substituting notations for the constraints Aₓ and I_{Xx} represented in the Y only column 406 of FIG. 4 as follows:

$${q}_{\{ 0 j 0 \}} = ( \frac{{A}_{Y}^{2}}{{I}_{Yy} - {A}_{Y}} ) {( 1 - \frac{{A}_{Y}}{{I}_{Yy}} )}^{j} = {A}_{Y} ( \frac{{A}_{Y}}{{I}_{Yy}} ) {( 1 - \frac{{A}_{Y}}{{I}_{Yy}} )}^{j - 1} \qquad ( 16 b )$$

Similarly, the notation of equation (16a) can be revised to define the panel probably distribution Q within platform Z only as follows:

$${q}_{\{ 00 k \}} = ( \frac{{A}_{Z}^{2}}{{I}_{Zz} - {A}_{Z}} ) {( 1 - \frac{{A}_{Z}}{{I}_{Zz}} )}^{k} = {A}_{Z} ( \frac{{A}_{Z}}{{I}_{Zz}} ) {( 1 - \frac{{A}_{Z}}{{I}_{Zz}} )}^{k - 1} \qquad ( 16 c )$$

In some examples, where impressions of media accessed by particular audience members via a combination of two and only two platforms are being analyzed, the probability distribution generator 606 may calculate associated probabilities for the panel probability distribution, similar to solving for impressions of audience members associated with only one platform outlined above. More particularly, for two and only two platforms (e.g., platforms X and Y only), the principle of maximum entropy can be used to calculate that the most accurate estimation for the panel data frequency distribution, Q, as one where the entropy, H, is maximized. This can be expressed as the following equation:

$$\begin{matrix}maximize \\ Q\end{matrix} H ( Q ) = - {\sum }_{i = 1}^{∞} {\sum }_{j = 1}^{∞} {q}_{\{ ij 0 \}} log ( {q}_{\{ ij 0 \}} ) \qquad ( 17 )$$

where the panel probability distribution Q is represented as a two-dimensional matrix of corresponding probabilities, q_{{ij0}}, where the ith dimension represents the number of impressions associated with platform X and the jth dimension represents the number of impressions associated with platform Y. Equation (17) is subject to the following constraints:

Σᵢ₌₁^{∞}Σⱼ₌₁^{∞}q_{{ij0}}=A_{XY} (18a)

Σᵢ₌₁^{∞}Σⱼ₌₁^{∞}iq_{{ij0}}=I_{XYx} (18b)

Σᵢ₌₁^{∞}Σⱼ₌₁^{∞}jq_{{ij0}}=I_{XYy} (18c)

where A_{XY}, I_{XYy}, and I_{XYx} are the unique audience size and impression count data associated with combination of platforms X and Y as defined in the XY column 412 of table 400 of FIG. 4 and q_{{ij0}} is the probability an audience member is associated with i impressions via platform X and j impressions via platform Y where i and j are both at least one. This equation set is analogous to example equation set (12). Relying on the data being disjoint, the solution to the individual probabilities of the two-platform portion of the panel data distribution Q can be expressed as:

q_{{ij0}}=z₁z₂⁽ⁱ⁾z₃^{(j)} (19)

where z₁, z₂, and z₃ are multipliers corresponding to the exponential constant raised to a first, second, and third Lagrange multiplier respectively (e.g., as defined in equation (4)). By substituting example equation (19), into example equation set (18) and simplifying using the solution to a geometric series, the following equations can be found:

$$\begin{matrix}{\sum }_{i = 1}^{∞} {\sum }_{j = 1}^{∞} {q}_{\{ ij 0 \}} = {\sum }_{i = 1}^{∞} {\sum }_{j = 1}^{∞} {z}_{1} {z}_{2}^{( i )} {z}_{3}^{( j )} = \frac{{z}_{1} {z}_{2} {z}_{3}}{( 1 - {z}_{2} ) ( 1 - {z}_{3} )} = {A}_{XY} & ( 20 a ) \\ {\sum }_{i = 1}^{∞} {\sum }_{j = 1}^{∞} {q}_{\{ ij 0 \}} = {\sum }_{i = 1}^{∞} {\sum }_{j = 1}^{∞} {iz}_{1} {z}_{2}^{( i )} {z}_{3}^{( j )} = \frac{{z}_{1} {z}_{2} {z}_{3}}{{( 1 - {z}_{2} )}^{2} ( 1 - {z}_{3} )} = {I}_{XYx} & ( 20 b ) \\ {\sum }_{i = 1}^{∞} {\sum }_{j = 1}^{∞} {jq}_{\{ ij 0 \}} = {\sum }_{i = 1}^{∞} {\sum }_{j = 1}^{∞} {jz}_{1} {z}_{2}^{( i )} {z}_{3}^{( j )} = \frac{{z}_{1} {z}_{2} {z}_{3}}{( 1 - {z}_{2} ) ( 1 - {z}_{3} )} = {I}_{XYy} & ( 20 c )\end{matrix}$$

Solving for z₁, z₂ and, z₃, then solving for q_{{ij0}} and simplifying yields the solution:

$${q}_{\{ ij 0 \}} = {A}_{XY} ( \frac{{A}_{XY}}{{I}_{XYx}} ) ( \frac{{A}_{XY}}{{I}_{XYy}} ) {( 1 - \frac{{A}_{XY}}{{I}_{XYx}} )}^{i - 1} {( 1 - \frac{{A}_{XY}}{{I}_{XYy}} )}^{j - 1} \qquad ( 21 a )$$

In some examples, the probability distribution generator 606 evaluates example equation (21) for all values of q_{{ij0}} to define the two-platform portion of the panel probability distribution Q associated with the combination of platforms X and Y but no other platforms. A similar analysis may be followed to define the panel probability distribution Q for the combination of platforms X and Z only (defined by q_{{i0k}} and associated with the XZ column 412 of FIG. 4) and for the combination of platforms Y and Z only (defined by q_{{0jk}} and associated with the YZ column 414 of FIG. 4) as follows:

$$\begin{matrix}{q}_{\{ i 0 k \}} = {A}_{XZ} ( \frac{{A}_{XZ}}{{I}_{XZz}} ) ( \frac{{A}_{XZ}}{{I}_{XZx}} ) {( 1 - \frac{{A}_{XZ}}{{I}_{XZx}} )}^{j - 1} {( 1 - \frac{{A}_{XZ}}{{I}_{XZz}} )}^{k - 1} & ( 21 b ) \\ {q}_{\{ 0 jk \}} = {A}_{YZ} ( \frac{{A}_{YZ}}{{I}_{YZy}} ) ( \frac{{A}_{YZ}}{{I}_{YZz}} ) {( 1 - \frac{{A}_{YZ}}{{I}_{YZy}} )}^{j - 1} {( 1 - \frac{{A}_{YZ}}{{I}_{YZz}} )}^{k - 1} & ( 21 c )\end{matrix}$$

When there are two platforms, as in this example, it is possible that some audience members will be exposed to media via one platform but not the other (e.g., when either i=0 or j=0). However, example equation (21a) is not valid for i=0 or j=0 because, as shown in equation (17), the infinite double sum begins at i=1 and j=1. The same is true for equations (21b) and (21c). Thus, example equation set (21) can only find probability values where the audience members had impressions via both of the two platforms being considered in combination. Accordingly, in some examples, to fully define the panel probability distribution Q for two platforms, the probability distribution generator 606 applies the appropriate equations from equation set 21 (for the combination of both platforms) and the appropriate equations from equation set 16 (for audience members with impressions via only one of the two platforms. In this matter, all value of q may be calculated to define the panel probability distribution Q.

A similar derivation may be employed to solve for individual probabilities of a system of three platforms, which may be expressed as follows:

q_{{ijk}}=z₁z₂⁽ⁱ⁾z₃^{(j)}z₄^{(k)} (22)

where z₁, z₂, z₃, z₄ are the Lagrange multipliers as exponents of the exponential constant. Similarly substituting in constraints yields an expression for the individual probabilities:

$${q}_{\{ ijk \}} = {A}_{XYZ} ( \frac{{A}_{XYZ}}{{I}_{XYZx}} ) ( \frac{{A}_{XYZ}}{{I}_{XYZy}} ) ( \frac{{A}_{XYZ}}{{I}_{XYZz}} ) {( 1 … - \frac{{A}_{XYZ}}{{I}_{XYZx}} )}^{i - 1} {( - \frac{{A}_{XYZ}}{{I}_{XYZy}} )}^{j - 1} {( 1 - \frac{{A}_{XYZ}}{{I}_{XYZz}} )}^{k - 1} \qquad ( 23 )$$

where A_{XYZ}, I_{XYZx}, I_{XYZy}, and I_{XYZz} are the unique audience sizes and impression counts associated with the combinations of platforms X, Y, Z as defined in the XYZ column 416 of table 400 of FIG. 4. For similar reasons as described above, this equation (23) is limited to probabilities of audience members corresponding to impressions across all three platforms X, Y, and Z (e.g., when i, j, and k are equal to or greater than 1). That is, audience members associated with equation 23 had at least one impressions via each of platform X, platform Y, and platform Z. Therefore, to fully define the panel distribution the example probability distribution generator 606 applies equation set (21) to solve for the probabilities involving two and only two platforms and applies the equation set (16) to solve for the probabilities of panelist audience members exposed to media via one and only one of the platforms. In this example implementation, all constraints listed in constraint table 400 have been used to calculate the panel probability distribution Q. Once this is done, the panel probability distribution is fully defined for the three platforms. Thus, in some examples, the equation sets (16), (21), and (23) may be stored in memory and accessed by the probability distribution generator 606 to calculate any particular probability or segment of the panel probability distribution desired for any combination of impressions across three platforms.

Additionally, in some examples, the probability distribution generator 606 uses the gathered panel data (e.g., the panel constraints as defined in table 400 of FIG. 4) in conjunction with the gathered census data (e.g., the marginal constraints as defined in table 302 of FIG. 3B) to estimate a census probability distribution corresponding to a total population in the area of interest. While the panel probability distribution is not strictly needed to generate a census probability distribution, as will be discussed below in conjunction with equation (27), equations (16), (21), and (23) that define the panel probability distribution as derived above are used to derive the equations for estimating the census probability distribution.

Using the panel constraints as prior information is useful because the marginal constraints are not disjoint. Rather, the marginal audience constraints (e.g., Âᵢ, Âⱼ, and Âₖ) may contain common audience members and, thus, cannot be considered individually. While the marginal constraints provide basic information regarding the total impression count and total unique audience size associated with each platform of interest, it may be desirable to estimate the interaction of the different platforms and the overlap of audience members represented in the audience size for each platform to provide a more complete picture of the exposure of audience members to media in a total population (whether panelists or non-panelists). Accordingly, in an example system of three platforms, examples disclosed herein estimate values for partitioned census terms analogous to the 20 panel constraints represented in the table 400 of FIG. 4. In some examples, this is accomplished by dividing the six known marginal constraints into the 20 separate impression counts and unique audience sizes corresponding to each platform and combination of platforms in a similar manner as the panel data is represented in FIG. 4. The way in which the marginal constraints are divided to define the partitioned census terms is determined based on the principle of minimum cross entropy with the panel data used as prior information. The relationship of the 20 partitioned census terms and each of the marginal constraints is represented in table 500 of FIG. 5 and can be expressed mathematically as follows:

Â_{X}+Â_{XY}+Â_{XZ}+Â_{XYZ}=Âᵢ (24a)

Â_{Y}+Â_{XY}+Â_{YZ}+Â_{XYZ}=Âⱼ (24b)

Â_{Z}+Â_{XZ}+Â_{YZ}+Â_{XYZ}=Âₖ (24c)

Î_{Xx}+Î_{XYx}+Î_{XZx}+Î_{XYZx}=\hat{T}ᵢ (24d)

Î_{Yy}+Î_{XYy}+Î_{YZy}+Î_{XYZy}=\hat{T}ⱼ (24e)

Î_{Zz}+Î_{XZz}+Î_{YZz}+Î_{XYZz}=\hat{T}ₖ (24f)

Â₀+Â_{X}+Â_{Y}+Â_{Z}+Â_{XY}+Â_{YZ}+Â_{XZ}+Â_{XYZ}=UE (24g)

Where the right-hand side of the equations (24a)-(24f) are the known marginal constraints defined by the census data as depicted in example table 302 of FIG. 3B. The total population or universe estimate (UE), is also assumed to be a known value that is separately available. The terms on the left-hand side of the equations correspond to the 20 different partitioned census terms represented in the example census table 500 of FIG. 5.

Each of the 20 different partitioned census terms may be calculated from a census probability distribution P based on the principle of minimum cross entropy with respect to an estimated panel probability distribution Q, as define above by equations (16), (21) and (23). Stated mathematically, the optimization problem can be stated:

$$\begin{matrix}minimize \\ P\end{matrix} D ( P \text{:} Q ) = {\sum }_{i = 0}^{∞} {\sum }_{j = 0}^{∞} {\sum }_{k = 0}^{∞} {p}_{( ijk )} log ( \frac{{p}_{( ijk )}}{{q}_{( ijk )}} ) \qquad ( 25 )$$

where p_{{ijk}} is the probability of an audience member having i impressions via first platform (e.g., platform X), j impressions via a second platform (e.g., platform Y), and k impressions via a third platform (e.g., platform Z). Thus, the census probability distribution P may be represented as a three-dimensional matrix of corresponding probabilities p_{{ijk}}. In equation (25), q_{{ijk}} is an element of the related three-dimensional panel probability distribution Q. Example optimization equation (25) is subject to the following census data constraints:

$$\begin{matrix}{\sum }_{i = 1}^{∞} {\sum }_{j = 0}^{∞} {\sum }_{k = 0}^{∞} {p}_{( ijk )} = \frac{{\hat{A}}_{i}}{UE} & ( 26 a ) \\ {\sum }_{i = 0}^{∞} {\sum }_{j = 1}^{∞} {\sum }_{k = 0}^{∞} {p}_{( ijk )} = \frac{{\hat{A}}_{j}}{UE} & ( 26 b ) \\ {\sum }_{i = 0}^{∞} {\sum }_{j = 0}^{∞} {\sum }_{k = 1}^{∞} {p}_{( ijk )} = \frac{{\hat{A}}_{k}}{UE} & ( 26 c ) \\ {\sum }_{i = 1}^{∞} {\sum }_{j = 0}^{∞} {\sum }_{k = 0}^{∞} {ip}_{( ijk )} = \frac{{\hat{T}}_{i}}{UE} & ( 26 d ) \\ {\sum }_{i = 0}^{∞} {\sum }_{j = 1}^{∞} {\sum }_{k = 0}^{∞} {jp}_{( ijk )} = \frac{{\hat{T}}_{j}}{UE} & ( 26 e ) \\ {\sum }_{i = 0}^{∞} {\sum }_{j = 0}^{∞} {\sum }_{k = 1}^{∞} {kp}_{( ijk )} = \frac{{\hat{T}}_{k}}{UE} & ( 26 f ) \\ {\sum }_{i = 0}^{∞} {\sum }_{j = 0}^{∞} {\sum }_{k = 0}^{∞} {p}_{( ijk )} = 1 & ( 26 g )\end{matrix}$$

The solution to example optimization equation (25), constrained by example equation set (26), can be found by partitioning or dividing the left-hand side based on the 20 partitioned census terms associated with the relevant marginal constraints (as described above and represented in the table 500 of FIG. 5). In contrast to the example equation set (24), the marginal constraints on the right-hand side of the equation set (26) have been normalized to the universal estimate. This is done because the right-hand side is expressed as probabilities such that the total of all probabilities (equation (26g)) sums to 1.

Take for example, the partition corresponding to the combination of platforms X and Y only. The individual census probability distributions associated with this combination is p_{{i,j,0}} and represents the probability of an audience member having at least 1 impression via platform X and at least one impression via platform Y. As such, in this example, p_{{i,j,0}} influences five marginal constraints including the total (census-wide) unique audience size specific to each of platforms X and Y (e.g., Âᵢ and Âⱼ associated with equations (26a) and (26b)), the total (census-wide) impression count specific to each of platforms X and Y (e.g., \hat{T}ᵢ and \hat{T}ⱼ associated with equations (26d) and (26e)), and the sum of all probabilities equaling 100% (e.g., equation (26g)). This can be expressed as:

p_{(i,j,0)}=q_{(i,j,0)}×(z₁z₂z₄ⁱz₅^{j}z₇) (27)

where the first term, q{i, j, 0}, is the prior calculated panel probability distribution element for the platform combination XY and the second term (z₁ z₂ . . . ) is a multiplicative factor with each z value representing a corresponding exponential Lagrange multiplier as defined in equation (4). In this example, each z value is associated with a different one of the seven constraints defined by the equation set (26), where subscripts identify the relevant constraint according to the ordinal placement of the constraints listed in the equation set (26) provided above. That is, the first multiplier z₁ corresponds to the first constraint equation (equation (26a)), the second multiplier z₂ corresponds to the second constraint equation (equation (26b)), and so forth. As shown in equation (27), the census probability distribution values are equal to the panel probability distribution values multiplied by a multiplicative factor. However, the multiplicative factor is unique for every cell in the distribution matrix because its value depends on the values of the indices i and j. Taking the sum of each side over the iteration factors, i and j beginning at 1 (while k=0 to exclude platform Z) accounts for all audience members exposed to media via both platform X and platform Y but not platform Z. The first term, q, substituted out for example equation (21a) and algebraically reduced using properties of sums of geometric series, gives:

$${\sum }_{i = 1}^{∞} {\sum }_{j = 1}^{∞} {p}_{\{ i , j , 0 \}} = \frac{{A}_{XY}^{3} {z}_{1} {z}_{2} {z}_{4} {z}_{5} {z}_{7}}{( {I}_{XYx} + {A}_{XY} {z}_{4} - {I}_{XYx} {z}_{4} ) ( {I}_{XYy} + {A}_{XY} {z}_{5} - {I}_{XYy} {z}_{5} )} = {\hat{A}}_{XY} \qquad ( 28 )$$

Similarly, the following equations for the other 7 partitioned census audience terms associated with the unique audience size for each platform or combination of platforms can be so derived:

$$\begin{matrix} {\sum }_{i = 1}^{∞} {p}_{\{ i , 0 , 0 \}} = \frac{{A}_{X}^{2} {z}_{1} {z}_{4} {z}_{7}}{( {I}_{Xx} + {A}_{X} {z}_{4} - {I}_{Xx} {z}_{4} )} = {\hat{A}}_{X} & ( 29 ) \\ {\sum }_{j = 1}^{∞} {p}_{\{ 0 , j , 0 \}} = \frac{{A}_{Y}^{2} {z}_{2} {z}_{5} {z}_{7}}{( {I}_{Yy} + {A}_{X} {z}_{5} - {I}_{Yy} {z}_{5} )} = {\hat{A}}_{Y} & ( 30 ) \\ {\sum }_{k = 1}^{∞} {p}_{\{ 0 , 0 , k \}} = \frac{{A}_{Z}^{2} {z}_{3} {z}_{6} {z}_{7}}{( {I}_{Zz} + {A}_{Z} {z}_{5} - {I}_{Zz} {z}_{5} )} = {\hat{A}}_{Z} & ( 31 ) \\ {\sum }_{i = 1}^{∞} {\sum }_{k = 1}^{∞} {p}_{\{ i , 0 , k \}} = \frac{{A}_{XZ}^{3} {z}_{1} {z}_{3} {z}_{4} {z}_{6} {z}_{7}}{( {I}_{XZx} + {A}_{XZ} {z}_{4} - {I}_{XZx} {z}_{4} ) ( {I}_{XZz} + {A}_{XZ} {z}_{6} - {I}_{XZz} {z}_{6} )} = {\hat{A}}_{XZ} & ( 32 ) \\ {\sum }_{j = 1}^{∞} {\sum }_{k = 1}^{∞} {p}_{\{ 0 , j , k \}} = \frac{{A}_{YZ}^{3} {z}_{2} {z}_{3} {z}_{5} {z}_{6} {z}_{7}}{( {I}_{YZy} + {A}_{YZ} {z}_{5} - {I}_{YZy} {z}_{5} ) ( {I}_{YZz} + {A}_{YZ} {z}_{6} - {I}_{YZz} {z}_{6} )} = {\hat{A}}_{YZ} & ( 33 ) \\ {\sum }_{i = 1}^{∞} {\sum }_{j = 1}^{∞} {\sum }_{k = 1}^{∞} {p}_{( i , j , k )} = \frac{{A}_{XYZ}^{3} {z}_{1} {z}_{2} {z}_{3} {z}_{4} {z}_{5} {z}_{6} {z}_{7}}{\begin{matrix}( {I}_{XYZx} + {A}_{XYZ} {z}_{4} - {I}_{XYZx} {z}_{4} ) ( {I}_{XYZy} + {A}_{XYZ} {z}_{5} - {I}_{XYZy} {z}_{5} ) \\ ( {I}_{XYZz} + {A}_{XYZ} {z}_{6} - {I}_{XYZz} {z}_{6} )\end{matrix}} & ( 34 ) \\ {A}_{0} {z}_{7} = {\hat{A}}_{0} & ( 35 )\end{matrix}$$

Each of these partitioned census audience terms are mutually exclusive, that is each audience member of the universe estimate is counted in one and only one of these terms.

In a similar manner, equations on the left-hand side of the equation set (24) for the other 12 partitioned census impression count terms corresponding to impressions counts for each platform and combination of platforms may also be derived based on an evaluation of the infinite sums of equations (16), (21), and (23) multiplied by a corresponding multiplicative factors made up of the z values associated with each relevant constraint influenced by the term being analyzed. The derived equations for each of the 12 partitioned census impression count terms are given as:

$$\begin{matrix}{\sum }_{i = 1}^{∞} {\sum }_{j = 1}^{∞} {ip}_{\{ i , j , 0 \}} = \frac{{A}_{XY}^{3} {z}_{1} {z}_{2} {z}_{4} {z}_{5} {z}_{7} {I}_{XYx}}{{( {I}_{XYx} + {A}_{XY} {z}_{4} - {I}_{XYx} {z}_{4} )}^{2} ( {I}_{XYy} + {A}_{XY} {z}_{5} - {I}_{XYy} {z}_{5} )} = {\hat{I}}_{XYx} & ( 36 ) \\ {\sum }_{i = 1}^{∞} {ip}_{\{ i , 0 , 0 \}} \frac{{A}_{X}^{2} {z}_{1} {z}_{4} {z}_{7} {I}_{Xx}}{{( {I}_{Xx} + {A}_{X} {z}_{4} - {I}_{Xx} {z}_{4} )}^{2}} = {\hat{I}}_{Xx} & ( 37 ) \\ {\sum }_{j = 1}^{∞} {jp}_{\{ 0 , j , 0 \}} \frac{{A}_{Y}^{2} {z}_{2} {z}_{5} {z}_{7} {I}_{Yy}}{{( {I}_{Yy} + {A}_{X} {z}_{5} - {I}_{Yy} {z}_{5} )}^{2}} = {\hat{I}}_{Yy} & ( 38 ) \\ {\sum }_{k = 1}^{∞} {kp}_{\{ 0 , 0 , k \}} \frac{{A}_{Z}^{2} {z}_{3} {z}_{6} {z}_{7} {I}_{Zz}}{{( {I}_{Zz} + {A}_{Z} {z}_{6} - {I}_{Zz} {z}_{6} )}^{2}} = {\hat{I}}_{Zz} & ( 39 ) \\ {\sum }_{i = 1}^{∞} {\sum }_{j = 1}^{∞} {jp}_{\{ i , j , 0 \}} = \frac{{A}_{XY}^{3} {z}_{1} {z}_{2} {z}_{4} {z}_{5} {z}_{7} {I}_{XYy}}{( {I}_{XYx} + {A}_{XY} {z}_{4} - {I}_{XYx} {z}_{4} ) {( {I}_{XYy} + {A}_{XY} {z}_{5} - {I}_{XYy} {z}_{5} )}^{2}} = {\hat{I}}_{XYy} & ( 40 ) \\ {\sum }_{i = 1}^{∞} {\sum }_{k = 1}^{∞} {ip}_{\{ i , 0 , k \}} = \frac{{A}_{XZ}^{3} {z}_{1} {z}_{3} {z}_{4} {z}_{6} {z}_{7} {I}_{XZx}}{{( {I}_{XZx} + {A}_{XZ} {z}_{4} - {I}_{XZx} {z}_{4} )}^{2} ( {I}_{XZz} + {A}_{XZ} {z}_{6} - {I}_{XZz} {z}_{6} )} = {\hat{I}}_{XZx} & ( 41 ) \\ {\sum }_{i = 1}^{∞} {\sum }_{k = 1}^{∞} {kp}_{\{ i , 0 , k \}} = \frac{{A}_{XZ}^{3} {z}_{1} {z}_{3} {z}_{4} {z}_{6} {z}_{7} {I}_{XZz}}{( {I}_{XZx} + {A}_{XZ} {z}_{4} - {I}_{XZx} {z}_{4} ) {( {I}_{XZz} + {A}_{XZ} {z}_{6} - {I}_{XZz} {z}_{6} )}^{2}} = {\hat{I}}_{XZz} & ( 42 ) \\ {\sum }_{j = 1}^{∞} {\sum }_{k = 1}^{∞} {jp}_{\{ 0 , j , k \}} = \frac{{A}_{YZ}^{3} {z}_{2} {z}_{3} {z}_{5} {z}_{6} {z}_{7} {I}_{XZy}}{{( {I}_{YZy} + {A}_{YZ} {z}_{5} - {I}_{YZy} {z}_{5} )}^{2} ( {I}_{YZz} + {A}_{YZ} {z}_{6} - {I}_{YZz} {z}_{6} )} = {\hat{I}}_{YZy} & ( 43 ) \\ {\sum }_{j = 1}^{∞} {\sum }_{k = 1}^{∞} {kp}_{\{ 0 , j , k \}} = \frac{{A}_{YZ}^{3} {z}_{2} {z}_{3} {z}_{5} {z}_{6} {z}_{7} {I}_{YZz}}{( {I}_{YZy} + {A}_{YZ} {z}_{5} - {I}_{YZy} {z}_{5} ) {( {I}_{YZz} + {A}_{YZ} {z}_{6} - {I}_{YZz} {z}_{6} )}^{2}} = {\hat{I}}_{YZz} & ( 44 ) \\ {\sum }_{i = 1}^{∞} {\sum }_{j = 1}^{∞} {\sum }_{k = 1}^{∞} {ip}_{( i , j , k )} = \frac{{A}_{XYZ}^{3} {z}_{1} {z}_{2} {z}_{3} {z}_{4} {z}_{5} {z}_{6} {z}_{7} {I}_{XYZx}}{\begin{matrix}{( {I}_{XYZx} + {A}_{XYZ} {z}_{4} - {I}_{XYZx} {z}_{4} )}^{2} ( {I}_{XYZy} + {A}_{XYZ} {z}_{5} - {I}_{XYZy} {z}_{5} ) \\ ( {I}_{XYZz} + {A}_{XYZ} {z}_{6} - {I}_{XYZz} {z}_{6} )\end{matrix}} = {\hat{I}}_{XYZx} & ( 45 ) \\ {\sum }_{i = 1}^{∞} {\sum }_{j = 1}^{∞} {\sum }_{k = 1}^{∞} {jp}_{( i , j , k )} = \frac{{A}_{XYZ}^{4} {z}_{1} {z}_{2} {z}_{3} {z}_{4} {z}_{5} {z}_{6} {z}_{7} {I}_{XYZy}}{\begin{matrix}( {I}_{XYZx} + {A}_{XYZ} {z}_{4} - {I}_{XYZx} {z}_{4} ) {( {I}_{XYZy} + {A}_{XYZ} {z}_{5} - {I}_{XYZy} {z}_{5} )}^{2} \\ ( {I}_{XYZz} + {A}_{XYZ} {z}_{6} - {I}_{XYZz} {z}_{6} )\end{matrix}} = {\hat{I}}_{XYZy} & ( 46 ) \\ {\sum }_{i = 1}^{∞} {\sum }_{j = 1}^{∞} {\sum }_{k = 1}^{∞} {kp}_{( i , j , k )} = \frac{{A}_{XYZ}^{4} {z}_{1} {z}_{2} {z}_{3} {z}_{4} {z}_{5} {z}_{6} {z}_{7} {I}_{XYZz}}{\begin{matrix}( {I}_{XYZx} + {A}_{XYZ} {z}_{4} - {I}_{XYZx} {z}_{4} ) ( {I}_{XYZy} + {A}_{XYZ} {z}_{5} - {I}_{XYZy} {z}_{5} ) \\ {( {I}_{XYZz} + {A}_{XYZ} {z}_{6} - {I}_{XYZz} {z}_{6} )}^{2}\end{matrix}} = {\hat{I}}_{XYZz} & ( 47 )\end{matrix}$$

Equations (28)-(47) define each of the 20 partitioned census terms on the left-hand side of equation set (24) in terms of 20 known panel constraints defined by the panel data and the seven exponential Lagrange multipliers (e.g., z₁, z₂, etc.) associated with the seven constraints of equation set (26). When equations (28)-(47) are substituted into example equation set (24), a system of seven non-linear equations with seven unknowns corresponding to the Lagrange multipliers. In some examples, equations (28)-(47) and/or the resulting seven non-linear equations are stored in memory for analysis once panel data has been received by the input data gatherer 602. In some examples, the probability distribution generator 606 of FIG. 6 solves the system of seven equations using numerical analysis.

In this example, solving the system of equations analytically yields a value for each of the seven exponential Lagrange multipliers. With each exponential Lagrange multiplier known, the example probability distribution generator 606 may evaluate each of equations (28)-(47) to generate estimates for each of the 20 partitioned census terms represented in the example table 500 of FIG. 5. Additionally, or alternatively, the generator 606 may use the solved values for the exponential Lagrange multipliers to calculate any desired probability within the census distribution P and/or more generally, define the census distribution using equation (27) and similar equations for each platform and/or platform combination of interest.

In the illustrated example, the report generator 608 outputs a summary of the panel constraints and/or the corresponding partitioned census terms and/or output other data indicative of the panel and/or census probability distributions or any designated segment thereof. The example report generator 608 may use the constraint tables 400 and 500, of FIGS. 4 and 5 respectively, populated with calculated unique audience size and impression count data to generate reports or estimates of any or all probabilities for the census and/or panel probability distribution(s). The example report generator 608 may produce a report in any physical medium (e.g. a paper printout) or digital medium (e.g. a spreadsheet, a graph, etc.). In some examples, the generated report may then be used to calculate any desired individual probability or any other sort of data analysis that can be performed on a probability distribution from the report.

While an example manner of implementing the impression frequency distribution analyzer 600 of FIGS. 1A, 1B, and 6 is illustrated in FIG. 6, one or more of the elements, processes and/or devices illustrated in FIG. 6 may be combined, divided, re-arranged, omitted, eliminated and/or implemented in any other way. Further, the example input data gatherer 602, the example constraint analyzer 604, the example probability distribution generator 606, the example report generator 608, and/or, more generally, the example impression frequency distribution analyzer 600 of FIG. 6 may be implemented by hardware, software, firmware and/or any combination of hardware, software and/or firmware. Thus, for example, any of the example input data gatherer 602, the example constraint analyzer 604, the example probability distribution generator 606, the example report generator 608, and/or, more generally, the example impression frequency distribution analyzer 600 of FIG. 6 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example input data gatherer 602, the example constraint analyzer 604, the example probability distribution generator 606, and/or the example report generator 608 is/are hereby expressly defined to include a non-transitory computer readable storage device or storage disk such as a memory, a digital versatile disk (DVD), a compact disk (CD), a Blu-ray disk, etc. including the software and/or firmware. Further still, the example impression frequency distribution analyzer 600 of FIG. 6 may include one or more elements, processes and/or devices in addition to, or instead of, those illustrated in FIG. 6, and/or may include more than one of any or all of the illustrated elements, processes and devices.

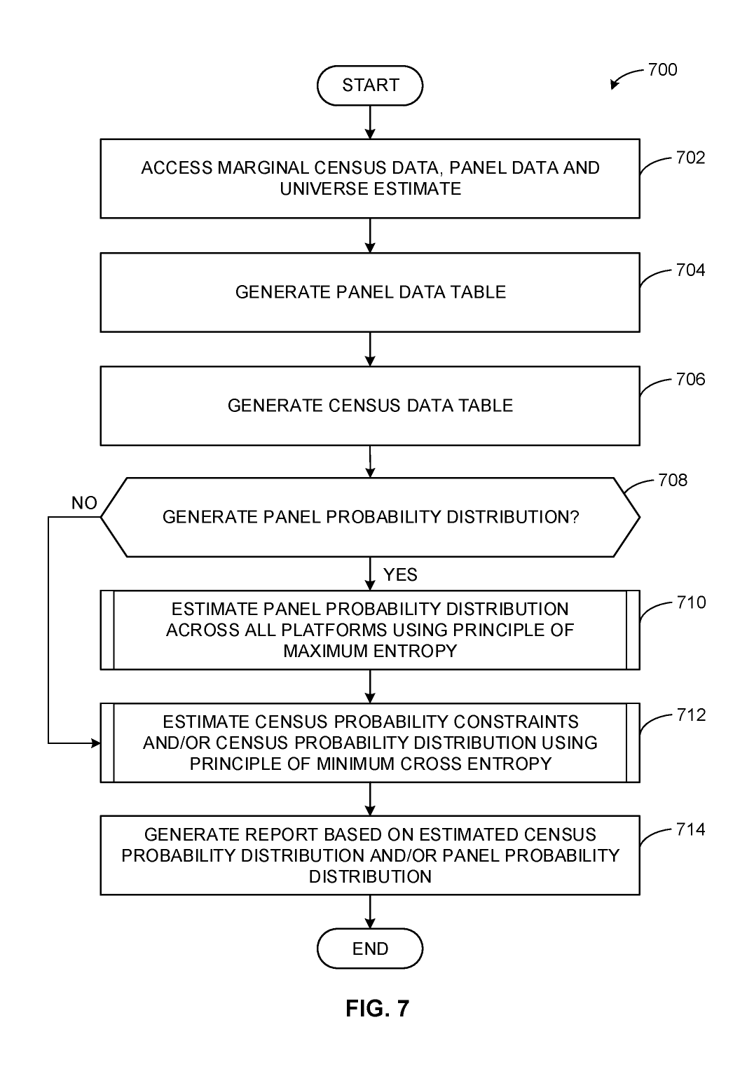

Flowcharts representative of example machine readable instructions for implementing the impression frequency distribution analyzer 600 of FIGS. 1A, 1B, and 6 are shown in FIGS. 7-9. In these examples, the machine readable instructions comprise one or more program(s) for execution by a processor such as the processor 1012 shown in the example processor platform 1000 discussed below in connection with FIG. 10. The program(s) may be embodied in software stored on a tangible computer readable storage medium such as a CD-ROM, a floppy disk, a hard drive, a digital versatile disk (DVD), a Blu-ray disk, or a memory associated with the processor 1012, but the entirety of the program(s) and/or parts thereof could alternatively be executed by a device other than the processor 1012 and/or embodied in firmware or dedicated hardware. Further, although the example program(s) are described with reference to the flowcharts illustrated in FIGS. 7-9, many other methods of implementing the example impression frequency distribution analyzer 600 may alternatively be used. For example, the order of execution of the blocks may be changed, and/or some of the blocks described may be changed, eliminated, or combined.

As mentioned above, the example processes of FIGS. 7-9 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 7-9 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 7 is a flow diagram of example machine readable instructions that may be executed to implement the example impression frequency analyzer 600 of FIG. 6 to calculate panel and/or census probability distributions and/or portions thereof. The example process 700 depicted in FIG. 7 begins at block 702. At block 702, the input data gatherer 602 (FIG. 6) accesses marginal census data, panel data and a universe estimate. For example, the input data gatherer 602 accesses data generated by the media meter 101 (FIG. 1A) and/or data proprietors 104a, 104b (FIG. 1B) stored by the AME 102 (FIG. 1A). In some examples, the input data gatherer 602 stores the accessed marginal census data, panel data and the universe estimate in local memory (e.g., the local memory 1013 of FIG. 10). In some examples, the panel data includes a complete platform disjoint dataset from panelists of the AME 102. By contrast, in some examples, the marginal census data includes non-disjoint platform datasets. That is, while the panelist data may be divided into mutually exclusive groups of data corresponding to each different platform or platform combination, the marginal census data is limited to total unique audience size and impression count for each platform of interest without any direct indication of the overlap and/or interrelationship of the different platforms. In some examples, this marginal census data includes marginal audience census data and marginal impression census data. In some examples, the input data also includes data extraneous to the example process 700.

At block 704, the example constraint analyzer 604 (FIG. 6) generates a panel data table. For example, the constraint analyzer 604 can generate the panel data distribution constraints table 400 of FIG. 4. In some examples, the constraint analyzer 604 generates the panel data table based on a memory management unit (e.g., the memory management unit (MMU) 1036 of FIG. 10) storing the panel data in a data structure in a block of volatile memory (e.g., the volatile memory 1014 of FIG. 10). At block 706, the example constraint analyzer 604 generates a census data table. For example, the constraint analyzer 604 can generate the marginal census data table 302 of FIG. 3B. In some examples, the constraint analyzer 604 generates the census data table based on a memory management unit (e.g., the memory management unit MMU 1036 of FIG. 10) storing the marginal census data in a block of volatile memory (e.g., the volatile memory 1014 of FIG. 10).

At block 708, process control determines if a panel data distribution is to be generated. In some examples, the processor 1012 (FIG. 10) determines, based on user input (e.g., a prompt through a user interface, such as the interface 1020 of FIG. 10, or a predetermined setting of the process), whether to calculate the panel distribution. In other examples, the processor 1012 makes such a determination based on a property of the data accessed by the data gatherer 602. For example, an arithmetic logic unit (e.g., the arithmetic logic unit (ALU) 1034 of FIG. 10) may be used to compare a particular value of the accessed data (e.g., the unique audience size corresponding to impressions via platform X) to a preset threshold value in a register 1035 (FIG. 10) to determine which is larger. If the value exceeds the threshold value, the processor 1012 determines that it should generate the panel data distribution. Regardless of how the decision is made, if the panel distribution is to be generated, the process proceeds to block 710. Otherwise, the process control advances to block 712.

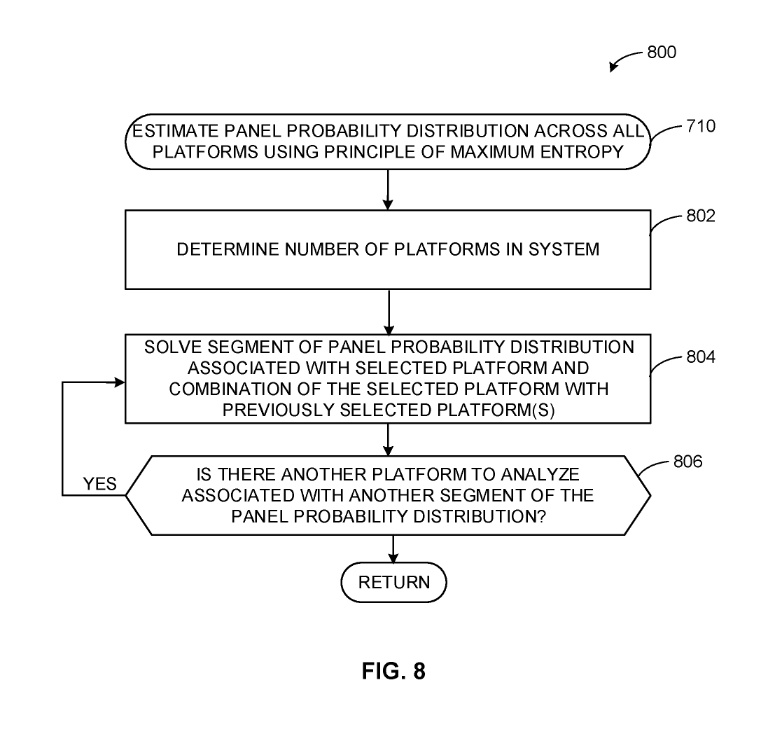

At block 710, the example probability distribution generator 606 estimates the panel probability distribution across all platforms using a principle of maximum entropy. In some examples, the example probability distribution generator 606 estimates the probability distribution at block 710 based on one or more ALUs 1034 (e.g., of the processor 1012 of FIG. 10, or any other processor) performing a series of calculations using the data in the volatile memory 1014 stored by the MMU 1036 and using equations (16), (21) and (23) to define a panel probability distribution. Once the example panel probability distribution is estimated, the distribution may be used to analyze and determine the probability of audience members being exposed to media via any platform or combination of platforms and with any number of impressions via the corresponding platform(s). This applies to both specific combinations of platform(s) and impressions(s) as well as specified segments of the panel probability distribution (e.g., individual cell probabilities and linear combinations). An example process that may be used to implement block 710 is described in greater detail below in connection with example process 800 of FIG. 8.

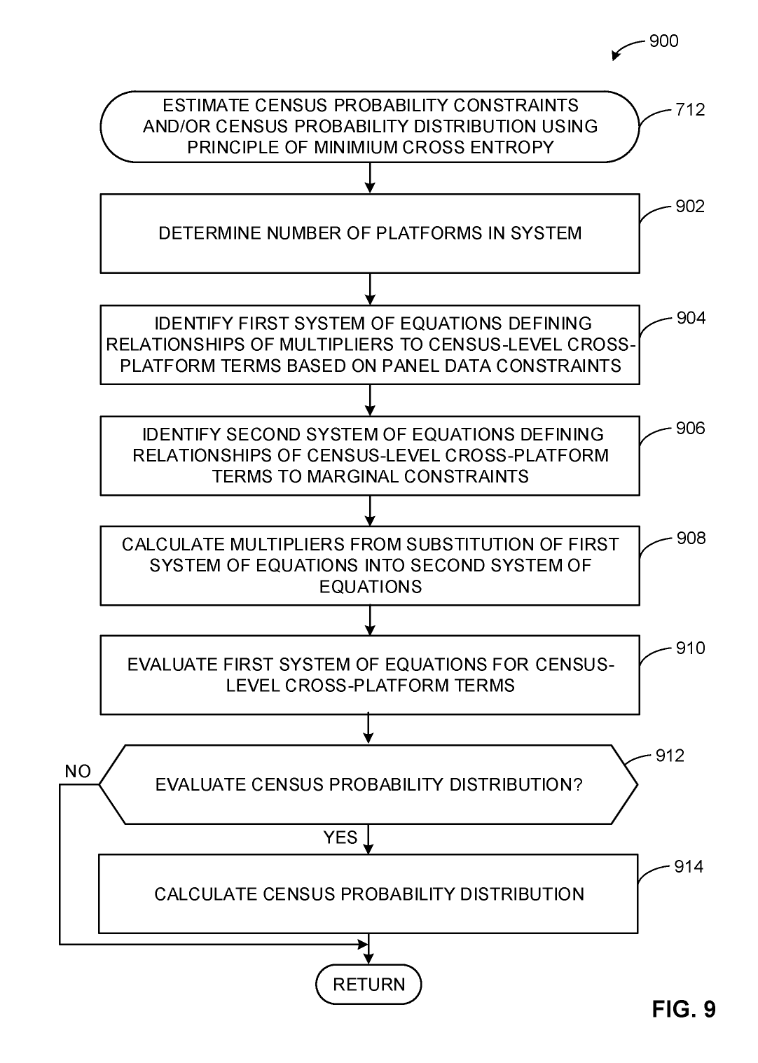

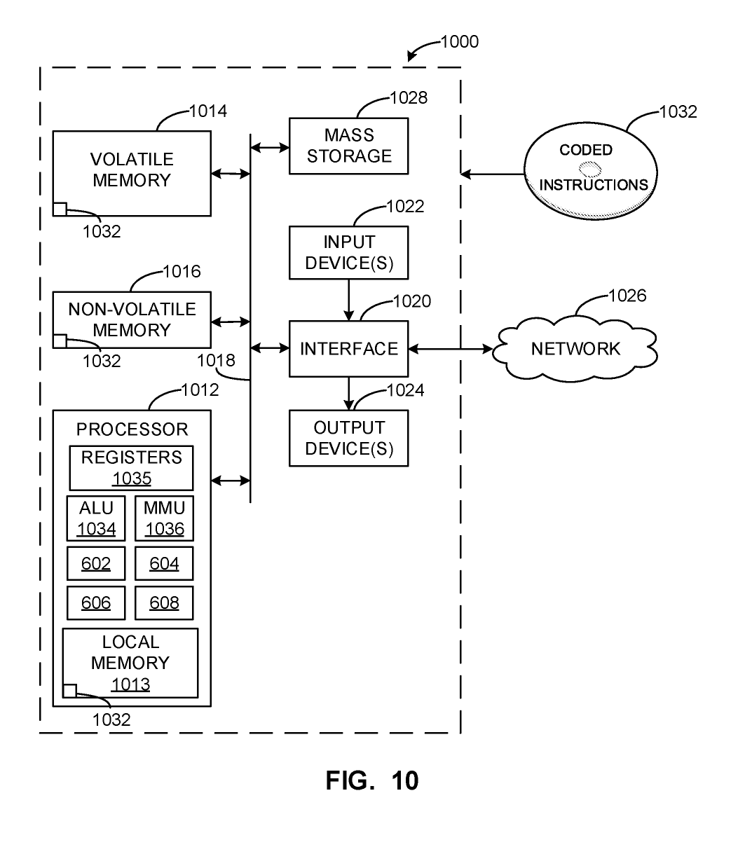

At block 712, the example probability distribution generator 606 estimates the census probability constraints and/or the census probability distribution using a principle of minimum cross entropy. For example, the example probability distribution generator 606 may calculate the census probability distribution based on one or more ALUs 1034 performing a series of calculations using the data in the volatile memory 1014 stored by the MMU 1036 based on an evaluation of equations (16)-(47) to define a census probability distribution. Once the example census probability distribution is estimated, the distribution may be used to analyze and determine the probability of audience members being exposed to media via any platform or combination of platforms and with any number of impressions via the corresponding platform(s). This applies to both specific combinations of platform(s) and impressions(s) as well as specified segments of the census probability distribution (e.g. individual cell probabilities and linear combinations). In some examples, the probability distribution generator 606 may not estimate the complete census probability distribution. Rather, the probability distribution generator 606 may estimate the particular segments of the distribution corresponding to the 20 partitioned census terms defined in table 500 of FIG. 5. These 20 values may be estimated based on a direct evaluation of the corresponding equations (28)-(47) as derived above. An example process that may be used to implement block 712 is described in greater detail below in connection with example process 900 of FIG. 9.

At block 714, the example report generator 608 (FIG. 6) generates a report based on the estimated census probability distribution (or the associated probability constraints) and/or the panel probability distribution. For example, the processor 1012 generates the report as an electronic document that includes estimated probabilities and/or estimated unique audience sizes and/or associated impression counts for particular platforms and/or platform combinations based on the panel probability distribution generated at block 710 and/or the census probability constraints and/or distribution generated at block 714. In some examples, the report includes a table, such as the example table 500 of FIG. 5, containing values for the impression count and unique audience sizes for each individual platform and combination of platforms for the entire census population. In some examples, the report generator may store the report in a hard drive (e.g., the mass storage 1028 of FIG. 10) and/or output the report to a connected device (e.g., the output device(s) 1024 of FIG. 10).

FIG. 8 is a flowchart illustrating the example process of block 710 in greater detail to estimate a panel probability distribution across all platforms using a principle of maximum entropy. This example process 800 begins at block 802, where the example constraint analyzer 604 (FIG. 6) determines the number of platforms in the system. For example, the example constraint analyzer 604 determines which data (e.g., unique audience sizes and impression counts associated with the panel data) accessed by the input data gatherer 602 (FIG. 6) at block 704 (FIG. 7) is relevant to the calculation of the panel probability distribution for the maximum entropy equation(s). In some examples, the constraint analyzer 604 determines how many platforms are being considered in the estimation of the probability distribution. In some examples, this consideration is based on a comparison of values performed by one or more ALU(s) 1034 (FIG. 10). For example, the constraint analyzer 604 may base the determination of the number of platforms to be considered on a value (e.g., the number of expected platforms) loaded into a first register (e.g., a register of the example registers 1035 of FIG. 10) by the MMU 1036 (FIG. 10) indicative of the number of platforms represented by the gathered panel data. In other examples, the number of platforms to be considered in the gathered panel data can be indicated by a user input. Regardless of how many platforms are to be considered, the constraint analyzer 604 designates a first one of the platforms as the first platform (e.g., platform X as defined with respect to the derivation of equations (11)-(23)), a second one of the platform as the second platform (e.g., platform Y as defined with respect to the derivation of equations (11)-(23)), and so forth.

At block 804, the probability distribution generator 606 solves for a segment of the panel probability distribution associated with a selected platform and the combination of the selected platform with previously selected platform(s). In some examples, the probability distribution generator 606 solves for the segment of the panel probability distribution based on the equation sets (16), (21), (23) associated with the selected platform and the associated combinations with other previously selected platforms. In some examples, the generator 606 evaluates the one-platform solution for the selected platform (e.g., by evaluating the relevant equations from equation set (16)). Where the analysis has already gone through a previously selected platform, the example generator 606 further evaluates the multi-platform solution(s) for the selected platform in combination with all previously analyzed platforms (e.g., with the relevant equations from equation sets (21) and (23)). In some examples, the generated panel probably distribution is generated by one or more ALUs 1034 performing a series of calculations using the data in the volatile memory 1014 stored by the MMU 1036 and using equations (16), (21) and (23) to solve the distribution for the selected platform.

At block 806, process control determines if there is another platform to analyze associated with another segment of the panel probability distribution. In some examples, the probability distribution generator 606 compares the number of platforms determined at block 802 with the number of platforms it has analyzed at block 804. In some examples, this determination is based on a comparison made by one or more ALUs of the number platforms to be incorporated into the panel probability distribution, loaded into a first register 1035 by a MMU 1036 to a number of platforms that have been analyzed during this analysis, loaded into a second register 1035 by a MMU 1036. If there is at least one more platform to be considered, the generator 606 selects another platform and proceeds to block 804. Otherwise, if all platforms to be considered have been analyzed, the process 800 ends.

Take, for example, a three-platform system, including platforms X, Y and Z, for which a panel probability distribution is to be defined. Beginning at block 802, the example constraint analyzer 604 determines that the system has three platforms that need to be analyzed and selects platform X as the first platform. The process 800 advances to block 804 and the example probability distribution generator 606 executes instructions that cause one or more ALUs 1034 to solve equation (16a). At this point, the example generator 606 has solved all possible combinations of the current selected platform, platform X, with the previous analyzed platforms (e.g., during the first iteration of the process there are no previously analyzed platforms so the only possible combination is platform X by itself) and then stores platform X as the first platform in memory 1014. The process advances to block 806 where the probability distribution generator 606 notes that there are still platforms to be analyzed, namely platforms Y and Z. The analyzer 604 then selects platform Y as the second platform and the process returns to block 804. At block 804, the generator 606 executes instructions to cause one or more ALUs 1034 to evaluate equation (16b) once (for platform Y by itself) and equation (21a) once (for platforms X and Y in combination). Repeating the process through block 804 and block 806, the analyzer 604 selects platform Z as the third platform and then executes instructions that cause one or more ALUs 1034 to evaluate equations (16b) once (for platform Z by itself), each of equations (21b) and (21c) (for the combinations XZ and YZ) and equation (23) once (for combination XYZ). At this point, the generator 606 has fully defined the panel probability distribution and returns to the main process 700.

While the above examples provide equations for up to three platforms, process 800 can be executed to find the panel probability distribution for any number of platforms in a similar manner. For each new platform beyond the third, new equations can be derived in accordance with the teachings disclosed herein to define the individual probabilities to fully specify the probability distribution for audience members corresponding to impressions on the corresponding platforms.

FIG. 9 is a flowchart illustrating the example process of block 712 in greater detail to estimate census probability constraints and/a census probability distribution using a principle of minimum cross entropy. This example process 900 begins at block 902, where the example constraint analyzer 604 (FIG. 6) determines the number of platforms in the system. In some examples, the example constraint analyzer 604 accesses the number of platforms to be covered from memory, as determined in block 802 (FIG. 8). In other examples, the constraint analyzer 604 determines the number of platforms to be covered in a manner similar to the method described in conjunction with block 802.

At block 904, the example probability distribution generator 606 identifies a first system of equations defining relationships of multipliers to partitioned census terms based on panel data constraints. In some examples, the multipliers are Lagrange multipliers or terms otherwise related to Lagrange multipliers (e.g., the z values as defined in equation (4)). For example, if at block 902 the constraint analyzer 604 determines there are three platforms in the system, the probability distribution generator 606 identifies equations (28)-(47) to evaluate, which relate the 20 partitioned census terms identified in table 500 of FIG. 5 (on the left-hand side in the equations) in term of the seven z multipliers and the 20 panel data constraints identified in table 400 of FIG. 4. In some examples, the equations (28)-(47) and/or machine readable instructions to evaluate such equations are stored in a local memory (e.g., the mass storage 1028 of FIG. 10). In some examples, with a different number of platforms to be considered, the probability distribution generator 606 identifies a system of equations analogous to equations (28)-(47) but for a different number of platforms.

At block 906, the probability distribution generator 606 identifies a second system of equations defining relationships of the partitioned census terms to the marginal constraints. For example, if in block 902 the constraint analyzer 604 determines there are three platforms in the system, the probability distribution generator 606 identifies equation set (24) to evaluate that specifies the relationship of the 20 partitioned census terms (on the left-hand side) and the marginal constraints (on the right-hand side). In other examples, with a different number of platforms to be considered, the probability distribution generator 606 identifies a set of equations analogous to equation set (24) but for a different number of platforms.

At block 908, the probability distribution generator 606 calculates the multipliers from a substitution of the first system of equations into the second system of equations. For example, in a three platform system, the probability distribution generator 606 uses equations (28)-(47) to modify equation set (24) such that the multipliers (e.g., the z terms) may be in terms of the known panel constraints and the known marginal constraints. In some examples, the resulting system of equations defined by the modified equation set (24) and/or machine readable instructions to evaluate the resulting system of equations may be stored directly in memory (e.g., the mass storage 1028) so that the equations (28)-(47) and equation set (24) do not need to be combined as above. In some examples, the probability distribution generator 606 evaluates the modified equation set (24) to solve for the multipliers (e.g., the exponential Lagrange factors z₁, z₂, z₃, z₄, z₅, z₆, and z₇). In some examples, this calculation is performed by one or more ALUs using data in the volatile memory 1014 stored by the MMU 1036 to evaluate the modified equation set (24). In some examples, the MMU 1036 then stores this in a block of the processor memory (such as the non-volatile memory 1016 of FIG. 10).

At block 910, the probability distribution generator 606 evaluates the first system of equations (identified at block 904) for the partitioned census terms. For example, in a three platform system, the probability distribution generator 606, using the calculated values for the multipliers, evaluates each of equations (28)-(47) to determine the estimated unique audience size associated exclusively with each individual platform and each combination of platforms as well as the associated impression counts associated exclusively with each individual platform and each combination of platforms. In other words, the example probability distribution generator 606 evaluates the equations to define all the terms needed to populate the table 500 of FIG. 5. In some examples, these calculations are performed by one or more ALUs using data in the volatile memory 1014 stored by the MMU 1036 to evaluate each of equations (28)-(47) for the partitioned census terms. In some examples, the MMU 1036 then stores these calculated values in a data structure similar to example table 500.

At block 912, process control determines if the census probability distribution is to be evaluated. In some examples, the processor 1012 (FIG. 10) determines, based on user input (e.g., a prompt through a user interface, such as the interface 1020 of FIG. 10, or a predetermined setting of the process), whether to calculate the census probability distribution. In other examples, the processor 1012 makes such a determination based on a property of the data gathered by the data gatherer 602 (FIG. 6). For example, an ALU 1034 may be used to compare a particular value of the gathered data (e.g., the unique audience size corresponding to impressions via platform X) to a preset threshold value in a register 1035 (FIG. 10) to determine which is larger. If the value exceeds the threshold value, the processor 1012 determines that it should generate the census data distribution. Regardless of how the decision is made, if the census probability distribution is to be generated, it proceeds to block 914. Otherwise, the process 900 ends.

At block 914, the probability distribution generator 606 calculates the census data distribution. For example, the probability distribution generator 606, using the calculated partitioned census terms from block 910, and equations analogous to equations (16), (21), (23) to solve for the census probability distribution. In some examples, this calculation is based on a series of calculations performed by one or more ALUs using data in the volatile memory 1014 stored by the MMU 1036 to evaluate a series of equations analogous to equations (16), (21), (23). Once the census data distribution is defined, process 900 ends.

FIG. 10 is a block diagram of an example processor platform 1000 capable of executing the instructions of FIGS. 7-9 to implement the example impression frequency distribution analyzer 600 of FIG. 6. The processor platform 1000 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors or controllers from any desired family or manufacturer. The hardware processor may be a semiconductor based (e.g., silicon based) device. The example processor 1012 includes at least one arithmetic logic unit 1034 to perform arithmetic, logical, and/or comparative operations on data in registers 1035. The example processor also includes a memory management unit 1036 to load values between local memory 1013 (e.g., a cache) and the registers 1035 and to request blocks of memory from a volatile memory 1014 and a non-volatile memory 1016. In this example, the processor 1012 implements the example input data gatherer 602, the example constraint analyzer 604, the example probability distribution generator 606, and the example report generator 608.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014,1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), and/or a peripheral component interconnect (PCI) express interface.

In the illustrated example, one or more input devices 1022 are connected to the interface circuit 1020. The input device(s) 1022 permit(s) a user to enter data and/or commands into the processor 1012. The input device(s) can be implemented by, for example, an audio sensor, a microphone, a camera (still or video), a keyboard, a button, a mouse, a touchscreen, a track-pad, a trackball, an isopoint device, and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1020 of the illustrated example, thus, typically includes a graphics driver card, a graphics driver chip and/or a graphics driver processor.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, redundant array of independent disks (RAID) systems, and DVD drives.

The coded instructions 1032 of FIGS. 7-9 may be stored in the mass storage device 1028, in the volatile memory 1014, in the non-volatile memory 1016, and/or on a removable non-transitory computer readable storage medium such as a CD or DVD.

From the foregoing, it will be appreciated that example methods, apparatus and articles of manufacture have been disclosed that estimate a distribution of the total population (census) exposure to an item of media across different platforms, given known panel data across the different platforms and marginal census data associated with each platform. In some examples, the census probability distribution may be fully defined to estimate the probability of an audience member having an impression of the media any particular number of times via any particular platform or combination of platforms. In some examples, the census probability distribution is defined based on estimates of mutually exclusive unique audience sizes and corresponding impression counts associated exclusively with particular ones of the platforms and exclusively with particular combinations of two or more of the platforms.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A processor system, comprising:
memory in circuit with a processor;
a memory management unit (MMU) to:
store, in a first block of the memory, first impression counts of first media impressions corresponding to panelists in a population that accessed media via one or more of a plurality of media access platforms; and
store, in a second block of memory, marginal impression counts for second media impressions corresponding to audience members in the population that accessed the media via the plurality of media access platforms, the audience members including both the panelists and non-panelists, ones of the marginal impression counts indicative of a total number of impressions of the media accessed via corresponding ones of the plurality of media access platforms; and
at least one arithmetic logic unit (ALU) to:
calculate multipliers relating a first probability distribution of the first media impressions to a second probability distribution of the second media impressions, the multipliers calculated based on constraints defined by the marginal impression counts for the second media impressions; and
calculate second impression counts of the second media impressions based on the multipliers, different ones of the second impression counts corresponding to different combinations of at least one of the plurality of media access platforms.

2. The processor system of claim 1, wherein the multipliers correspond to Lagrange multipliers.

3. The processor system of claim 1, wherein a first one of the second impression counts is either (1) associated exclusively with a first one of the plurality of media access platforms or (2) associated exclusively with a combination of at least two of the plurality of media access platforms.

4. The processor system of claim 1, wherein the audience members associated with different ones of the second impression counts are mutually exclusive.

5. The processor system of claim 1, wherein the first impression counts of the first media impressions correspond to different disjoint sets of the first media impressions associated exclusively with (1) each one of the plurality of media access platforms and (2) each different combination of two or more of the plurality of media access platforms.

6. The processor system of claim 1, wherein the at least one ALU is to calculate the second probability distribution based on the multipliers.

7. The processor system of claim 1, wherein the first probability distribution satisfies a principle of maximum entropy with respect to the first impression counts and associated first unique audience sizes.

8. The processor system of claim 1, wherein the second probability distribution satisfies a principle of minimum cross entropy with respect to the first probability distribution as constrained by the constraints.

9. The processor system of claim 1, wherein the MMU is to store first unique audience sizes associated with the first media impressions, and to store marginal unique audience sizes associated with the marginal impression counts, the at least one ALU to calculate a second unique audience size corresponding to the audience members associated with the second impression count based on the multipliers.

10. The processor system of claim 9, wherein the constraints are defined by the first impression counts, the marginal impression counts, the first unique audience sizes, and the marginal unique audience sizes.

11. A non-transitory computer readable medium comprising instructions that, when executed, cause a processor to at least:
store, in a first block of the memory, first impression counts of first media impressions corresponding to panelists in a population that accessed media via one or more of a plurality of media access platforms; and
store, in a second block of memory, marginal impression counts for second media impressions corresponding to audience members in the population that accessed the media via the plurality of media access platforms, the audience members including both the panelists and non-panelists, ones of the marginal impression counts indicative of a total number of impressions of the media accessed via corresponding ones of the plurality of media access platforms;
calculate multipliers relating a first probability distribution of the first media impressions to a second probability distribution of the second media impressions, the multipliers calculated based on constraints defined by the marginal impression counts for the second media impressions; and
calculate second impression counts of the second media based on the multipliers, different ones of the second impression counts corresponding to different combinations of at least one of the plurality of media access platforms.

12. The non-transitory computer readable medium of claim 11, wherein, the multipliers correspond to Lagrange multipliers.

13. The non-transitory computer readable medium of claim 11, wherein a first one of the second impression counts is either (1) associated exclusively with a first one of the plurality of media access platforms or (2) associated exclusively with a combination of at least two of the plurality of media access platforms.

14. The non-transitory computer readable medium of claim 11, wherein the audience members associated with different ones of the second impression counts are mutually exclusive.

15. The non-transitory computer readable medium of claim 11, wherein the first impression counts of the first media impressions correspond to different disjoint sets of the first media impressions associated exclusively with (1) each one of the plurality of media access platforms and (2) each different combination of two or more of the plurality of media access platforms.

16. The non-transitory computer readable medium of claim 11, wherein the instructions further cause the processor to calculate the second probability distribution based on the multipliers.

17. The non-transitory computer readable medium of claim 11, wherein the first probability distribution satisfies a principle of maximum entropy with respect to the first impression counts and associated first unique audience sizes.

18. The non-transitory computer readable medium of claim 11, wherein the second probability distribution satisfies a principle of minimum cross entropy with respect to the first probability distribution as constrained by the constraints.

19. The non-transitory computer readable medium of claim 11, wherein the instructions further cause the processor to:
store first unique audience sizes associated with the first media impressions;
store marginal unique audience sizes associated with the marginal impression counts; and
calculate a second unique audience size corresponding to the audience members associated with the second impression count based on the multipliers.

20. (canceled)

21. A method, comprising:
storing, in a first block of memory by a memory management unit (MMU), first impression counts of first media impressions, the first media impressions corresponding to panelists in a population that accessed media via one or more of a plurality of media access platforms;
storing, in a second block of memory by the MMU, marginal impression counts for second media impressions corresponding to audience members in the population that accessed the media via the plurality of media access platforms, the audience members including both the panelists and non-panelists, ones of the marginal impression counts indicative of a total number of impressions of the media accessed via corresponding ones of the plurality of media access platforms;
calculating, by executing an instruction with a processor, multipliers relating a first probability distribution of the first media impressions to a second probability distribution of the second media impressions, the multipliers calculated based on constraints defined by the marginal impression counts for the second media impressions; and
calculating, by executing an instruction with the processor, second impression counts of the second media based on the multipliers, different ones of the second impression counts corresponding to different combinations of at least one of the plurality of media access platforms.

22-30. (canceled)
